(19) United States
(12) Patent Application Publication
(10) Pub. No.: US 2004/0059634 A1
(43) Pub. Date: Mar. 25, 2004

(54) Computerized system for a retail environment

(76) Inventors: Michael A. Tami, Feeding Hills, MA (US); John Sarno, Wilbraham, MA (US); John Vaillancourt, Canton, CT (US)

Correspondence Address: McCormick, Paulding & Huber LLP, City Place II, 185 Asylum Street, Hartford, CT, 06103-3402, US

(21) Appl. No.: 10/254,730

(22) Filed: Sep. 24, 2002

(51) Int. Cl. G06F 17/60

(52) U.S. Cl. 705/17

(57) ABSTRACT

A computerized system for a retail environment including a host computer, an in store processor in electrical communication with the host computer, and a Point Of Sale system. The Point Of Sale system includes a primary point of sale server in electrical communication with the in store processor, and a POS terminal in electrical communication with the primary point of sale server. The POS terminal includes a central processing unit, a cashier display, and a customer display. The cashier display and the customer display are directly controlled by the central processing unit such that they are interactive with each other.

### CROSS REFERENCE TO RELATED APPLICATIONS

Some of the material disclosed herein is disclosed and claimed in the following U.S. patent application Ser. No. 10/242,560, filed Sep. 11, 2002 entitled “POINT OF SALE SYSTEM AND METHOD FOR RETAIL STORES”, by Michael Tami, et al., which is hereby incorporated by reference.

### BACKGROUND OF THE INVENTION

Retail marketing of consumer goods in the United States has become increasingly sophisticated over the last decade. The trend has been to increase use of technology including computers not only in the areas of accounting and finance, but also in terms of inventory control and analysis.

In certain sectors of retailing, such as the food and grocery sales, the trend towards increased computerization has coincided with other trends. These would include larger and larger conglomerates in chains of stores and a raised level of expectation on the part of customers for improved amenity service and a range of goods. The result is the growth of “super stores” having a very large volume offering all the services of bakery, butcher shops, as well of the traditional supermarket. In addition, customers no longer expect to see a rather bland and somewhat sterile supermarket environment, but now expect to see something which is more akin to a high-end luxury retailer.

The expectations of customers in this regard move in the opposite direction to that which has occurred in other aspects such as hardware and home repair, wherein the customer has come to expect fewer amenities in exchange for lower prices. This has led to the development of retail chains, which in some cases are barely disguised warehouses. Such retail stores minimize expenditures and amenities and therefore reap the cost savings associated with that environment. In contrast, large-scale supermarket chains, which are being forced to move in the opposite direction, must incur greater expenses in creating a more luxurious and high tech retail environment. These expenditures naturally help depress profits per sale. Moreover, large retail establishments such as superstores create similarly large problems in controlling inventory, personnel, etc., which cost must be absorbed as well.

In an effort to regain loss margins and improve overall profitability, large scale food retailers, such as the Assignee of the present invention, have sought to use technology to the utmost to squeeze out every cost possible and realize every benefit.

In that regard, retailers have imported a variety of computerized techniques to attack all aspects of the business, including computerized databases for finance and accounting, store inventories, customer databases in terms of check cashing privileges, and a variety of store promotions which are aided by the use of computers and other high technology components.

As a result of the development of technology in the retail area, a series of databases has been created, which have proved useful in helping lower the operating costs of the individual stores as well as the enterprise itself. Similarly, retail stores and manufactures have broadly utilized database technology in the development of promotions, such as coupons, over many years, to help move product as well as stimulate interest in new products. Stores and manufacturers worked in conjunction to generate and operate promotions, which may include stamps, coupons, and the like, in order to stimulate customer interest.

However, information that was recorded by the manufacturers was limited to the product, product size, and other information pertaining to that individual package and the store at which it was sold as well as the date of purchase. One limitation to this approach is that it causes both manufacturers and food retailers to guess as to what would be the most effective promotion as well as what would be the wants and needs of a particular customer.

In general, the nature of the interaction between the customer and the food retailer has limited the chances for overall interaction between the customer and the retailer given the fact that there is only one point in which the customer and employees of the retailer have come into contact on an assured basis, and that is at the point of sale.

Point of sale systems in large retail store chains, e.g., supermarket chains, can process upwards of 25,000 customer transactions per store per week. A point of sale (POS) system for a typical large retail store may include 20 front-end checkout lanes and five or more peripheral checkout areas in order to process the volume of customers that go through the store each day. Many of the retail store's business strategies and marketing initiatives are technologically integrated with the store's POS system. This is because, it is at the point of sale that the store often has its best opportunity to exchange information and gather data from the customer.

Problematically however, prior art POS systems lack many important capabilities necessary for proper support of required store data gathering functions, business strategies and/or marketing initiatives. Additionally, these prior art POS systems are not fully electronically integrated with the store's host computer system. For example, prior art POS systems do not make full use of multi-media for various in-store system functions such as: cashier training, customer line management, and promotions. Additionally, the prior art systems do not make use of multimedia for POS related equipment such as special purpose kiosks and shopping carts.

Moreover, inventory management systems are interfaced with the store's host computer, however they are not currently integrated with prior art POS systems. Accordingly, this hinders the implementation of such inventory management functions as:

a) fully automated generation of orders to replenish merchandise, based on POS scan data; and

b) cycle count inventory support, including entering quantity, retail and costs into the POS system from the inventory management system.

Another problem with prior art POS systems is that the customer receipt is not fully user definable. Often times it is desirable to format and customize a receipt type (including interspersed color printing) based on store requirements and customer needs. This ability does not exist on current POS systems. For example, the prior art POS systems lack the ability to determine where a discount will print, e.g., immediately following the line item against which the discount was taken, after all items participating in a “multi-item” deal promotion have been recorded, or at the end of the transaction in a summary statement. Additionally, the ability to print on the receipt the savings that a customer “would have earned” if they had been a member of the preferred shoppers program is also lacking. Also, the prior art POS systems lack the ability to print on the receipt targeted promotional information to different customers based on their customer profiles stored in the host computer.

Checkout lanes in POS systems will often have a customer display. However the customer displays do not include full customer interactive capabilities. Additionally the customer display is not visible or in close proximity to the cashier. The only way for a cashier to see the customer display or assist the customer is to leave the cashier area and go around the check stand to where the customer is standing. There is currently no function to allow the cashier to control the customer display and assist the customer from the check stand.

Direct store delivery (DSD) systems are PC-based DSD applications, which run entirely independent of prior art POS Systems. Accordingly, current POS systems do not have the ability to automatically update DSD costs on a daily basis. Additionally, stock transfers and shipments (typically store to store) are currently done manually and are not integrated with current POS systems. That is the prior art POS systems cannot forecast a stock shortage and, based on that forecast, generate an inter-store stock transfer to prevent the shortage.

Kiosks are often used throughout a retail store, however, current POS systems are not fully integrated with these kiosks. As a result, the kiosks cannot be utilized to perform a variety of interactive customer/POS functions such as the ability to swipe cards and receive customer specific ‘deals’ and to interface with the POS system.

Preferred shopper programs commonly include the use of “smart cards” adapted to interface with POS system terminals to store a customer's demographic profile data, transaction history and incentive indicia. Such “smart cards” are disclosed, for example, in U.S. Pat. No. 6,129,274 entitled “SYSTEM AND METHOD FOR UPDATING SHOPPING TRANSACTION HISTORY USING ELECTRONIC PERSONAL DIGITAL SHOPPING ASSISTANT”. Likewise, preferred shopper programs sometimes use data mining for retrieval and consolidation of information from multidimensional or relational databases to reveal buying behavior. U.S. Pat. No. 6,334,110, for example, discloses a “SYSTEM AND METHOD FOR ANALYZING CUSTOMER TRANSACTIONS AND INTERACTIONS”.

Preferred shopper programs disclosed in the prior art, however, are typically directed to the public at large, or to a segment of the public identified by transaction history and demographic profile data maintained by the store. Where the customer base is comprised of a wide cross-section of the population, as in the case of a supermarket chain, promotional activities may be effective only within a small segment of the population or may lag market trends. Particularly in the case of a supermarket chain, intense competition for market share and profitability require increasingly adaptable and targeted marketing strategies that are flexible enough to meet rapidly changing market trends and a shifting customer base.

Based on the foregoing, it would be advantageous to have a system and method of providing and/or acquiring information directly from a consumer (customer) as to the wants and needs with regards to sales in a retail setting.

It would also be advantageous to provide a computerized system for a retail environment, e.g., a supermarket chain, that overcomes the problems and drawbacks associated with the prior art.

### SUMMARY OF THE INVENTION

The present invention offers advantages and alternatives over the prior art by providing a computerized system for a retail environment which can enhance interaction between a customer and a cashier at a point-of-sale. Additionally, the system provides relational databases of customer data which are updated on a substantially real time basis as items are being rung through at each point of sale in each store of the retail environment.

An exemplary embodiment of the present invention provides a computerized system for a retail environment including a host computer, an in store processor in electrical communication with the host computer, and a Point Of Sale system. The Point Of Sale system includes a primary point of sale server in electrical communication with the in store processor, and a POS terminal in electrical communication with the primary point of sale server. The POS terminal includes a central processing unit, a cashier display, and a customer display. The cashier display and the customer display are directly controlled by the central processing unit such that they are interactive with each other.

In another embodiment the system includes a secondary point of sale server in electrical communication with the primary point of sale server. The primary point of sale server has sufficient memory to include a plurality of relational databases which receive and store date from the Point Of Sale system. The primary and secondary point of sale servers are interactive such that the plurality of relational databases are updated on a substantially real time basis.

In an alternative embodiment the in store processor of the computerized system includes an inventory management system which is integrated with the relational databases of the primary point of sale server. The inventory management system is updated on a substantially real time basis.

### BRIEF DESCRIPTION OF THE DRAWINGS

FIG. 1 is a schematic diagram of a computerized retail system in accordance with the present invention.

FIG. 2 is a block diagram of a preferred embodiment of the point of sale system and method of the present invention.

FIG. 3 shows an embodiment of a customer display used in the point of sale system and method of FIG. 2.

FIG. 4 is a block diagram of the overview of the shopper savings programs of the point of sale system and method of FIG. 2.

FIG. 5 is a flowchart of a special event utilized by the business method of the present invention.

FIG. 6 is a flowchart of a Turkey Coin program utilized by the business method of the present invention.

FIG. 7 is a flowchart of a multi-colored coin program utilized by the business method of the present invention.

FIG. 8 is a flowchart of a multi-colored coin program with accelerated earnings utilized by the business method of the present invention.

FIG. 9 is a flowchart of a Platinum Coin program utilized by the business method of the present invention.

FIG. 10 is a block diagram of the targeting method utilized by the business method of the present invention.

FIG. 11 is a flowchart of continuity offers provided by the business method of the present invention.

FIG. 12 is a flowchart of limited continuity offers provided by the business method of the present invention.

FIG. 13 is a flowchart of a rain-check program provided by the business method of the present invention.

FIG. 14 is a flowchart of an embodiment of an educational or charitable giving program provided by the business method of the present invention.

### DETAILED SPECIFICATION OF THE PREFERRED EMBODIMENT

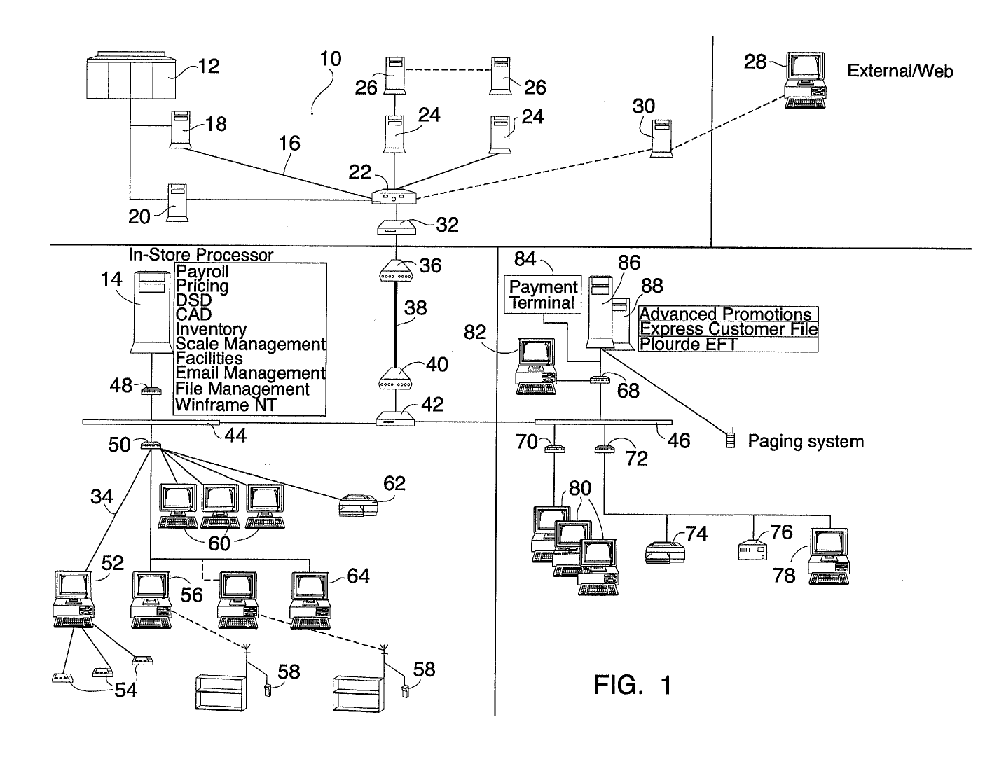

Referring to FIG. 1, a computerized retail system 10 supports an entire chain of multiple retail stores. The computerized retail system 10 includes a host 12 computer remotely located from an In-Store-Processor (ISP) 14. The host 12 would typically be located at a company headquarters, while the ISP 14 would typically be located at each retail store within a chain of stores covering a given geographic region.

The host 12 is in electrical communication with a variety of switches, servers and routers, which form a host Local Area Network (LAN) 16. In this embodiment the host 12 is electrically connected to a pair of dedicated host servers 18 and 20, which are connected in parallel to switch 22. The dedicated host servers 18 and 20 include memories that store databases which support the host computer 12. The servers 18 and 20 may also be used to process database queries. The switch 22 is a device that filters and forwards data being transmitted throughout the host LAN 16.

Also connected to the switch 22 are a variety of main servers 24 and their backup servers 26. The main servers 24 add memory and speed to the host computer 12 through high speed connections of the host LAN 16. The backup servers 26 provide redundancy to the system 10.

The switch 22 is connected to the external internet or world wide web 28 through firewall 30. The firewall 30 may be a system designed to prevent access to or from the computerized retail system 10. The firewall 30 may be implemented in both hardware and software, or a combination of both. All messages entering of leaving the computerized retail system 10 pass through the firewall 30, which examines each message and blocks those that do not meet the specified security criteria.

The switch 22 is also connected to a router 32. Router 32 interfaces the host LAN 16 with an In-Store LAN 34 of each store to form a corporate Wide Area Network (WAN) or corporate intranet. In addition to connecting the two LANs 16 and 34, the router 32 provides additional functionality such as the ability to filter messages and forward them to different places based on various criteria.

The WAN is based on TCP/IP protocols belonging to the organization, which are accessible only by the organization's members, employees or others with authorization. The WAN computer network may span a relatively large geographical area to connect all the in store LANs of the entire enterprise. Computers connected to a WAN network are often connected through public networks, such as the telephone system using T3 carriers. They can also be connected through leased lines such as T-1 carriers for high speed communications, or through satellites.

The Router 32 is connected directly to a combination Channel Service Unit/Data Service Unit (CSU/DSU) 36 located near the host LAN 16. A DSU is a device that performs protective and diagnostic functions for a telecommunications line. A CSU is a device that connects a terminal to a digital line. Typically, the two devices are packaged as a single unit, such as in CSU/DSU 36, and may be thought of as being analogous to a very high speed modem. Such a device is required for both ends of a T-3 or T-1 connection, and the units at both ends must usually be from the same manufacturer to be compatible.

In this embodiment, the CSU/DSU 36 connects to one end of a leased T-1 line (or carrier) 38 located near the host LAN 16. The other end of the T-1 line 38 connects the matching CSU/DSU 40 located near the in-store LAN 34. The T-1 line 38 is a dedicated phone connection supporting data rates of 1.544 Mbits per second. The T-1 line typically consists of 24 individual channels, each of which supports 64 Kbits per second. Each 64 Kbit per second channel can be configured to carry voice or data traffic.

The in-store CSU/DSU 40 is connected to an in-store router 42. The in-store router 42 is in parallel connection with In-Store Processor bus 44 (ISP bus) and Point-Of-Sale bus 46 (POS bus). The ISP bus 44 is also connected to a pair of hubs 48 and 50.

Hubs 48 and 50 are the common connection points for devices in a network such as the in-store LAN 34. The hubs 48 and 50 are used to connect segments of the in-store LAN 34. The hubs 48, 50 contain multiple ports. When a packet of data arrives at one port, it is copied to the other ports so that all the segments of the LAN 34 can see all the packets.

The hubs 48 and 50 may be of many types, e.g., passive, intelligent or switching. A passive hub serves simply as a conduit for the data, enabling it to go from one device (or segment) to another. Intelligent hubs include additional features that enable an administrator to monitor the traffic passing though the hub and to configure each port in the hub. A switching hub actually reads the destination address of each packet and then forwards the packet to the correct port.

Hub 48 is connected to the In-Store Processor (ISP) 14. As will be discussed in greater detail hereinafter, the ISP 14 controls such in-store functions as the inventor management system, store payroll, store pricing, store ordering, store receiving and a Direct Store Delivery (DSD) system. Additionally the ISP controls such in-store management systems as the scale management system, facilities management, e-mail management and file management.

Hub 50 is connected to the scale management terminals 52, which control the calibration and pricing of the in-store scales 54 distributed throughout the store. Additionally, the hub 50 is connected to electronic shelf label (ESL) terminals 56, which include ESL applications such as those available from Electronic Retailing Systems International Inc. or Telepanel Systems Inc. The ESL terminals 56 provide wireless communications to hand held units 58.

The hand held units 58 are designed to read the bar code of stock items. The hand held units 58 are interfaced with an in-store Point Of Sale (POS) system and the inventory management system discussed earlier to provide and display current inventory and pricing data on each stock item bar code that it reads. The data includes such information as:

1) current price per item;

2) the quantity of items currently in stock; and

3) the amount of items sold so far that day.

Advantageously, the handheld units 58 can be linked to the inventory management system, POS system and ISP 14 through the high speed corporate intranet to update the data displayed in substantially real time, e.g., minute by minute. Moreover, the handheld units 58 can be programmed to query the ISP 14 to provide computer assisted ordering information for the stock item read.

Hub 50 is also connected to variety of in-store desk top computers 60, sign and label printers 62, and people planner terminals 64. Additionally, the handheld units 58 are in wireless communication with at least one telepanel terminal 66.

The POS bus 46 is in parallel connection to switches 68, 70 and 72. The switch 72 is connected to such devices as customer receipt terminals 74, self scanning stations 76 and interactive retailing personal service terminals 78. Switch 70 is dedicated to in-store POS terminals 80. Switch 68 is connected to such devices as the managers console 82, payment terminals 84 and the primary and secondary POS servers, 86 and 88 respectively.

The primary POS server 86 has sufficient memory to include relational databases for the POS system. Relational databases, or relational database management systems, are a type of database management system that stores data in the form of related tables. Relational databases are powerful because they require few assumptions about how data is related or how it will be extracted from the data base. As a result the same database can be viewed and analyzed in many different ways. For example, a database of in-store-inventory can be analyzed for generating computer assisted re-stocking orders, or be analyzed for customer purchasing preferences in a given geographic location.

The high speed server receives and stores input data from the POS system and updates the relational databases of the primary in-store on a real time basis as store items are being “rung up” at the point of sale. The primary POS server 86 is also in communication with the inventory management system stored on the ISP 14. Accordingly, the inventory management system is updated virtually at the same time and rate as the relational data bases on the primary POS server 86.

However, point of sale systems in large retail environments, e.g., large supermarket store chains, can process upwards of 25000 customer transactions per store per week. Processing and analyzing this amount of data through the relational data bases consumes an enormous amount of memory and other computer resources, which in turn slows processing speed. In order to accomplish the updates of the data bases of the primary POS server 86 with sufficient speed, the secondary POS server 88 is not used as a back-up server in the traditional sense. That is the secondary POS server 88 is not programmed for complete redundancy of the information stored in the relational databases of the primary POS server 86. Rather the secondary POS server 88 is programmed to accomplish some of the analytical functions that the primary POS server 86 would normally perform, in order to free up memory and increase processing speed. Some of these functions include, for example:

Managing the Advanced Promotions files; and

Managing the Express Customer Files.

The advantage of the above combination is that the primary POS server 86 can update the POS system and the inventory management system on a real time basis. Moreover, because of the high speed corporate intranet connections of the corporate WAN, the host computer 12 can also receive and update the entire enterprise wide system virtually on a substantially real time basis as well, e.g., minute by minute.

The server 70 is dedicated to the POS terminals 80. The POS terminals include a single central processing unit (CPU) which is directly wired to, and supports, both a customer display and a cashier display. As a result, the customer display and cashier display are completely interactive on a real time basis. That is as the cashier rings items through at a point of sale, both displays may show the same information. Additionally, the POS terminal may include a software or hardware switch to allow the cashier to take control of the customer display in order to assist the customer without having to leave the cashier's station.

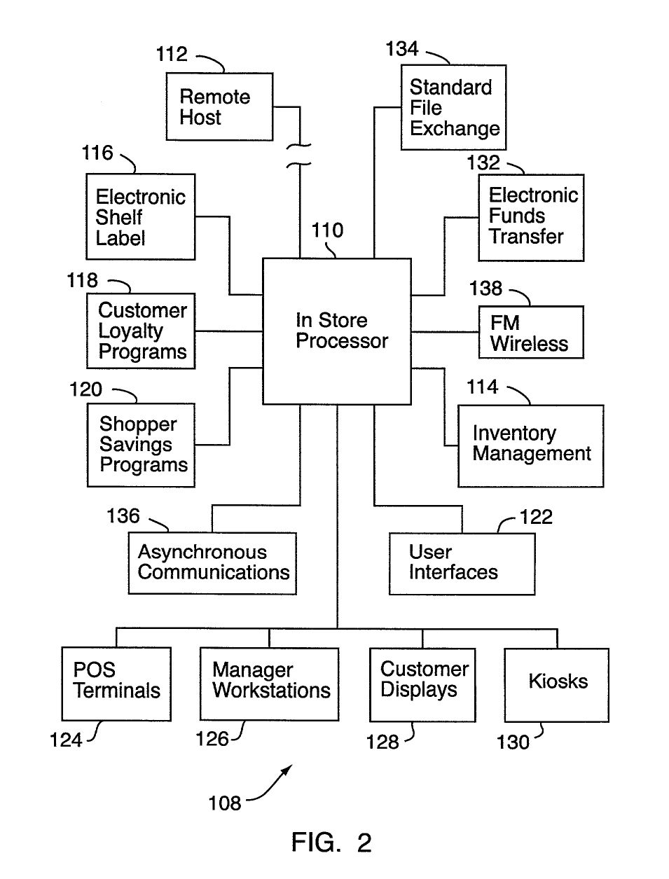

Referring to FIG. 2, an exemplary embodiment of a point-of-sale (POS) system in accordance with the present invention is shown generally at 108. The POS system 108 relies on the in-store processor (ISP) 110, that controls such in-store functions as the inventory management system 114 (often supported by merchandise/category management software packages such as “Turnkey Merchant” provided by “Turnkey Business Solution”) for store ordering, store receiving, store pricing and Direct Store Delivery (DSD); electronic shelf label (ESL) applications 116 (such as those available from Electronic Retailing Systems International Inc. or Telepanel Systems Inc.); customer loyalty programs 118; shopper savings programs 120 and wireless FM communications 138 to support automation technology (such as the BASS 7000 audit system). The ISP 110 also interfaces with a remote Host computer 112 located off-site at company headquarters for example. Diagnostics, advanced promotion programs and customer files typically reside on the Host Computer 112.

The ISP 110 also supports all of the user interfaces 122 including Point-of-Sale (POS) terminals 124, manager workstations 126, customer displays 128 and kiosks 130. Additionally, the ISP 110 of the present invention supports Electronic Funds Transfer (EFT) tender authorization 132, Standard File Exchange (SFX) communications 134, and Asynchronous communications 136 for such functions as remote diagnostics and Host-ISP communications. All of the foregoing communications occur via a wide area network (WAN).

In the preferred embodiment, transmission between the ISP 110 and the Host 112 is in “ECS” type message format: Messages are typically 362 bytes in length in ASCII format, with time-out parameters. Each message consists of two (2) headers and a Host/ISP/POS system specific data record. In the preferred embodiment the Host/ISP interface emulates the NCR NDP EFT standard.

The computerized POS system 108 of the present invention also supports the remote download of all software from the Host 112 to the POS terminals 124 at any time without interruption to normal store operations. The ability to remotely download software to the ISP 110 and the POS terminals 124/workstations 126 from the Host 112 is typically handled via 3271, bi-sync transmission mode.

Electronic shelf labeling (ESL) 116 applications such as those available from Tele-Panel Inc. and ERS Inc. are automatically updated whenever any price change occurs at the POS terminals 124. Before a batch price change is processed or applied, the communication link between the POS terminal 124 and the ESL PC 116 is validated. If the communication link between the POS terminal 124 and the ESL PC is down, the batch price change is blocked from updating on the POS terminal, and is renumbered for execution either manually or automatically when the connection is reestablished and a message is generated on the POS terminal 124 that notifies store personnel that a batch is in the “holding” area for execution. All auto-updating occur on the POS system 124 as scheduled.

Referring still to FIG. 2, the POS terminals 124 of the present invention preferably supports at least twenty check-out keyboard layouts and a minimum of two different supervisor/manager layouts. In the preferred embodiment, the POS terminals 124 also supports self-check-out systems, multiple pay points, multi-media systems and Electronic/Home shopping.

Input devices/interfaces may alternatively be keyboards, signature capture devices, touch-screen terminals or dyna-key components. The POS terminals 124 also preferably supports a variety of operator display options including standard CRT, Flat Panel CRT and Single/Two Line LED that are comprehensive and easily understood by the operator. The layout preferably allows for display of the last five items entered as well as the current item being entered with full forward and backward scrolling capability. The type of keyboard and keyboard layout utilized by each POS terminal 124 is individually definable as a component of the terminal application

Significantly, each POS terminal 124 can support both a customer display 128 as well as a cashier display 129 at the checkout counter. As a result the customer display 128, which will be described in detail hereinafter, is fully interactive with the cashier display 129 on a real time basis. For example, information that is displayed on the cashier display 129 as the merchandise is being “rung up” will also be displayed on the customer display 128. Additionally, the cashier display 129 may have a software switch to take control of the customer display 128, thus enabling the cashier to assist the customer without having to step onto the other side of the counter.

The manager workstation(s) 126 is typically a monochrome video display terminal with an attached 40 column receipt printer and a 132 column line printer.

Referring still to FIG. 2, in an important aspect of the business method of the present invention, the POS system 108 is integrated with the inventory management system 114, to capture and track all inventory received and shipments against invoice, as well as quantity ordered vs. quantity received. In the preferred embodiment, the method of the present invention allows for automatic stock replenishment based on POS scan data with re-order points configurable in the inventory file.

Moreover, by integrating the inventory management system 114 with the POS system 108, it is possible to implement such inventory management functions as:

a) fully automated generation of orders to replenish merchandise, based on POS scan data; and

b) cycle count inventory support, including entering quantity, retail and costs into the POS system from the inventory management system.

Significantly, the inventory management system 114 is updated in substantially real time, preferably on a minute by minute basis, from input date received from the POS system 108 as well as other inputs. Additionally, the inventory management system 114 of each store is integrated together, e.g., via high speed intranet connections, throughout the entire chain of retail stores to provide substantially real time updates and monitoring on an enterprise wide basis.

The integrated inventory management system 114 of the present invention tracks item movement at the item level by time (hh:mm) day, week and event, forecasts re-order requirements and issues stock level alerts. Stock level alerts may be based alternatively on a pre-set quantity for each store by category or by tracking and reporting quantities. Tracking includes production bulk sales tracking (updating an item file based on weight sales (used in food production)); tracking of items on hand and on order via the inventory file; and tracking line items by date, time and category for specific periods.

The inventory management system 114 software is typically managed from the Host 112, but it utilizes transaction data extracted from the POS System 108. The ability to fully track item movement at the PLU file level (the PLU file, or Price Look Up file, is described in detail herein below) is an important aspect of the inventory management system 114 of the present invention, and includes the ability to track sales by individual PLU number on a substantially real time basis, e.g., daily, hourly or by minute.

The integrated inventory management system 114 of the present invention preferably includes scale management to provide file coordination between the POS system 108 and the scale management system. Scale management systems such as Hobart Scale Master Systems, Toledo Scale Management Systems and Digi-Scale are exemplary embodiments of the scale management system of the present invention.

In a preferred embodiment of the invention, the POS system 108 is also fully integrated with a Direct Store Delivery (DSD) system (often a sub-set of the inventory management system 114). By integrating with the DSD system, the POS system 108 has the ability to automatically update DSD costs on a daily basis. Additionally, stock transfers and shipments (typically store to store) may be done automatically, rather than manually. This enables the POS system 108 or inventory management system 114 to forecast a stock shortage and, based on that forecast, generate an inter-store stock transfer to prevent the shortage.

Referring still to FIG. 2 in the preferred embodiment, the computerized POS system 108 of the present invention incorporates interactive customer kiosks 130 used in multiple locations throughout the store for various purposes including the ability to swipe card and receive customer specific ‘deals’, look up recipes, obtain Express Customer information summaries, and participate in surveys, for example.

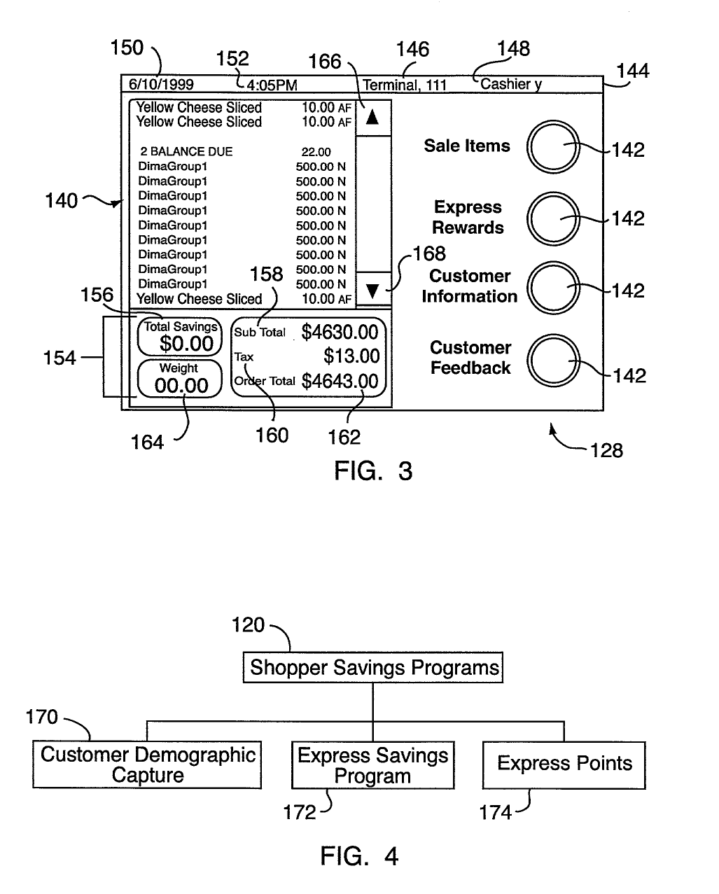

Another important aspect of the POS system 108 of the present invention is the use of an additional customer display 128 for use by the customer (best seen in FIG. 3). Customer display embodiments include CRT, Flat Panel CRT and Single/Two line LCD/LED, and Touch Screen. In one embodiment the customer display 128 has full graphics and motion video capability. As will be more fully described below, with reference to FIG. 3, the customer displays 128 of the present invention accommodate a variety of customer interactive programs such as customer surveys, as well as self check-out scanners with remote pay point, and multi-media programs (i.e., shopping carts, customer line management) and home shopping. Customer CRT displays may also support a running Tax Total, Food Stamp Total, Points Earned and Triple Coupons Earned.

Referring to FIG. 3, a customer display 128, located at the point of sale such as a POS terminal 124, is used interactively by the customer to view the receipt and for customer demographic information capture. In the embodiment shown, the customer display 128 is a flat panel touch screen colored LCD display with a split screen. The screen preferably includes a scrolling receipt 140 on one side, and soft touch keys 142, for in-lane customer access to retail store applications on the other side. During idle time, between transactions, the store logo may appear across both sides of the customer display 128. In the preferred embodiment, the Customer display 128 is fully customizable to meet the requirements of a particular store within a retail chain and includes customer interactive capabilities, multi-color and full graphics capabilities, as well as motion video capability.

The first item scanned or key entered will trigger “Sales Mode”. During “Sales Mode”, the left-hand side of the display scrolls the customer receipt 140. The right hand side of the display provides access to retail store applications through the use of the soft (touch) keys 142. In the preferred embodiment, the customer receipt side of the display 140 will provide a Status Line 144 with Terminal Number 146, Cashier Name 148, Date 150 and Time 152 as indicated; a Customer Receipt 140; an Order Summary 154 showing Total Savings 156, Sub-Total 158, Tax 160, and Order Total 162; and Scale Weight 164. In the preferred embodiment transaction control information (Terminal #, Operator #, Store #, Transaction #, Date/Time Stamp, etc.) may be positioned in either the header or the trailer.

Alternative configurations of the customer display 128 might include, for example, Food Stamp Total, preferred shopper points Earned and/or Triple Coupons earned.

As noted above, the Customer Receipt 140 is user definable allowing the customer to determine, within a range of parameters, what prints on the receipt, in what order and in what location, as well as receipt size. This includes, for example, the ability to determine where a discount will print, e.g., immediately following the line item against which a discount was taken, after all items participating in a “multi-item” deal promotion have been recorded, or at the end of the transaction in a summary statement. Customer receipt 140 types include terminal generated throw receipts (40 columns minimum), credit/debit receipts, rebate receipts and multi-part form receipts.

Referring still to FIG. 3, as items are processed, they appear on the Customer Receipt 140. The first item scanned appears at the bottom of the receipt and as items are scanned or key-entered, the display scrolls upward. When the number of items processed exceeds the screen's capacity, the customer has the option to scroll the receipt with “up” 166 and “down” 168 arrow buttons. The scroll buttons (“up” and “down” arrows, 166 and 168 respectively) only appear when the items in the sales order have exceeded the display capacity. When the scroll buttons are enabled, they increment one line at a time, on the customer receipt.

If the customer elects to scroll on the receipt, using the buttons, 166 and 168, he/she takes control over the displaying of the customer receipt. At this point, items processed are buffered and will not appear on the customer display 128. This, however, does not impact cashier order processing. The customer has control of the display until inactivity is detected after “X” number of seconds. If the scrolling is left idle for “X” number of seconds, the display reverts to the bottom of the receipt and displays the last item scanned. The number of seconds of inactivity is controlled by an ISP system parameter.

The right hand side of the customer display 128 provides access to retail store applications, pictures or AVIs (Audio Video Interleave). Access to retail store applications is preferably through the use of softkeys 142. In the preferred embodiment, the point of sale application is also linked to an Internet browser, controlled by the ISP 110. When a softkey 142 is pressed, the ISP retrieves and displays a DHTML (Dynamic HTML) page generated by the retail store in a DHTML script using an Active X component to return the focus to the point of sale application. The DHTML page provides information on sales items, rewards for preferred shoppers, customer information, and provides for customer feedback.

The POS system 108 of FIG. 2 is adapted for the use of multi-media throughout the store for a wide variety of functions. These functions include, but are not limited to: cashier training, visual PLU look-ups at the POS terminals 124, customer line management (e.g., the ability to use video graphics to entertain customers waiting in check-out lines, in-store specials, community information, news clips, etc.) video devices on shopping carts to alert customers to specials, promotions and in-store directories.

System Files/Databases Supported

The POS system 108 of the present invention includes a method of collecting demographic and transaction information for transmission to the Host computer 112. In the preferred embodiment any and all information entered into the POS system is available for collection, and the number of days of data collected information that can be stored is limited only by the size of the hard disk. Specific information to be collected is determined by parameters set by personnel at the retail store who can select and de-select what information will be stored in the data collect files. File structure is preferably SIL compliant.

Databases or Files supported by the computerized POS system 108 depicted in FIG. 2 include the following:

Store File

Terminal Application File

Communications File

PLU/Price File

Promotional File

Department File

Tax Tables

Cashier/Operator File

Messages File

Receipt Messages File

Express Customer File

Tender File

Negative Check File

Positive Check File

Negative Gift Certificate (redemption) File

Electronic Gift Certificate (issue) File

Raincheck File

Sold Money Order File

Electronic Journal File; Restore and Purge Information

Batch Maintenance File

Data Collection File

System Extracts; Department(s), Range of UPCs, etc.

Reset of Specific Period Totals (e.g., reset movement and sales on all PLUs that were active from the previous week.)

For each file, the POS system 108 of the present invention supports the ability to restrict access and/or modification by field. Likewise, the system preferably supports the ability to assign supervisory authorization levels by file, function and field.

Negative Check, Positive Check, Negative Gift Certificate, Electronic Gift Certificate and Cashier/Supervisor files are preferably unlimited in the number of records supported by the system for their respective files.

The system also preferably supports an unlimited number of extracts and is able to extract on any and all fields within the PLU File (see below). The extracts should be able to operate at any and all times, in any range, in any and all departments, by entire PLU file. On items with movement extracts are preferably able to restore one specific field or all fields.

The PLU file, Express Customer file, the Electronic Journal File, the Data Collect file, and the Tender file are described in detail below.

I. PLU File

The PLU file (or Price Look Up file) stores not only base prices and discounts but also Express Points Program requirements. (The Express Points Program is more particularly described below.) The PLU file preferably supports at least the following field requirements:

PLU Number;

Unit Price;

Package Multiple/Package Price (i.e., 2/0.89);

POS Description (minimum 20 character);

Department Number;

Coupon Family Code;

Selective Itemizers (determines taxable/food stampable, status);

Weight Limit (limit weighed items not to sell above this weight);

Inventory Count (keep running on-hand inventory);

Quantity Limit (limit items to not sell more than this count);

Sale Markdown (calculates difference between regular price and sale price for each item sold on sale);

Sale Counter (running total of how many of the items have sold at sale price);

Other Markdown (calculates difference between regular price and alternate price);

Other Counter (running total of how many of the items have sold at alternate price);

Scale Item (indicates whether or not an item is to be placed on scale at checkout);

Journal Print;

Data Collect (indicates if the record is to be data collected);

Restrict Sale Date (indicates if an item can/cannot be sold (SundaySaturday format);

Restrict Sale Time (indicates time period in which an item cannot be sold. e.g., using military time in a string format (i.e., 8:05 pm-7:55 am=20050755);

Tare;

Report Code;

Sale Price/Sale Dates/Time-MM/DDNYNY; HH:MM format;

Order Trigger;

Unit Count;

Net Item Sales;

Alternate Retail/Alternate Dates/Time-MM/DDNYNY; HH:MM format

Express Points program data maintained in the PLU file include the following fields:

Points Field #2

Points Quantity Limit

Points Begin/End Date

Points Net Sales

Points Count

Points quantity limit

Preferred Customer Package Price

Preferred Customer Package Quantity

Preferred Customer Net Item Sales

Preferred Customer Item count

II. The Express Customer File.

The Express customer file includes transaction information about each Express Customer. Express Customer File Updates and Record Layout Communications are typically handled via 3271, bi-sync protocol. An Express Customer Record file is typically structured as follows:

Fields

Transaction Date

Beginning Transaction Time

Card Number

Terminal Number

Cashier Number

Transaction Number

Order Amount

Order Total

Real Customer Flag

Ending Transaction Time

For Each Item Tracked

UPC Number

Quantity

Department Number

Price

Express Savings

Sales Savings

Void Flag

For Each Type of Tender

Tender Type

Tender Total

For Each Active Department

Department Number

Total Dollars

Sale Retail Savings

Sale Retail Dollars

Sale Retail Items

Department Total Savings

Department Express Savings

Department Total Items

Department Express Items

For Every Transaction With Triple Points

Points Earned

Points Redeemed

Triples Earned

Triples Redeemed

Filler/Delimiters

Total Record Size

III. The Electronic Journal

The Electronic Journal provides the ability, both by the ISP 110 and the host 112, to generate ad hoc reports based on any and all information captured by the POS System 108 including the ability to “pre-design” reports for use at store level for in-store application. Likewise the present invention includes the ability to disallow “ad hoc” report creation at store level.

The electronic journal tracks daily transactions and store transaction files for an indefinite time period, generally limited only by disk space. A back-up copy of the electronic journal files is maintained at the store level and is also limited only by available disk space. The Electronic Journal preferably includes the option of auto-deleting Electronic Journal days/periods as defined in a pre-set parameter. In the preferred embodiment Electronic Journal files can be archived, queried, and restored, either by an in-store supervisor or from a remote site (host).

Preferably, any field in the Electronic Journal file is able to be queried and be available to be displayed, printed or spooled to a file. Appropriate authorization levels are required for both in store and remote personnel. In the preferred embodiment the electronic journal query (polling) function is flexible enough to support query searches by individual fields, categories or ranges (extracts) and other specific criteria, such as:

by Voids,

by Preferred Customer Number,

by ATM/Credit Card #,

by Any and All Overrides,

by Any and All Loans,

by Any and All Pickups,

by Any and All Cashier Settlements and

by Tender Type.

IV. The Promotion File

The Promotion File provides the ability to support promotional features and typically includes the following information:

Promotion Number

Promotion Type

Pool-Tier

Coupon promotions up to four (4) levels preferably

Total Points (4 levels)

Beginning and End-Dates for promotions

Transaction Total

Departmental Points Promotions with breakpoint levels (4)

V. Data Collect File

The data collect file includes data pertaining to the customer ID, item points and promotion points. The computer system of FIG. 1 supports the ability to pre-set data collect files in a “flat file” format for upload to the host 112.

Preferably, there are three segments in which points information is data collected. These segments are contained within the transaction set:

POINTS ITEM SEGMENT

UPC Number

Department Number

Points (redeemed for coupon-type UPC)

Item Quantity

Super Points Multiplier

Customer ID Available Flag

Negative/Positive Points Flag

PROMOTION SEGMENT

Promotion Number

Points Coupon UPC Number

Points Awarded

Super Points Multiplier

Customer ID Available Flag

CUSTOMER SEGMENT

Alternate ID Type

Customer ID

Customer ID Flag (valid or NOF)

Total Points Earned

Total Points Redeemed

Total Savings for Points Redeemed

Minimum Order Itemizer

The Points Item Segment is only be generated when a UPC item contains points. All points segments should be generated whether or not customer ID has been presented.

VI. Tender File

The Tender File is preferably flexible enough to be customized and supports the ability to “personalize” the following fields in the tender file for each tender type:

Tender Description

Account Number Entry/Capture Required

Authorization Required

CDV Validation Required/Scheme

Customer Name Recognition

Single Tender Only Allowed

Minimum/Maximum Amount

Change Allowed

Maximum Cash Back Amount Allowed

Open Drawer

Pick-Up and Loan Allowed

Cash Drawer Limit (pre-set cash drawer limits)

Media Exchange (e.g., check cashing)

Allowed To Resolve.Credit Balance

Identification Required

Floor Limit in Off-Line Condition

EndorsementValidation Requirements

Print Requirements

In the preferred embodiment, all files have the ability to be transmitted to the Host 112 in either batch mode or via trickle poll, and the computerized POS system 108 of FIG. 2 is able to discern between information that has and has not been previously transmitted and will transmit only that information that has not been previously transmitted.

POS off-line

The POS terminals 124 of the present invention also functions in an off-line (lane independent) mode. When in the off-line mode, the POS system 108 alerts store personnel of an off-line condition, and the POS terminal 124 enters an off-line condition. EFT authorizations and Express customer functions requiring record retrieval from the Host 112 will not be available. Off-line each POS terminal 124 has available at least a base Price Look-Up (PLU) file, a promotions file, and an electronic journal. In the preferred embodiment, the offline POS terminal 124 also has the flexibility to support any files required to continue operations, including information reporting requirements, negative and positive check files, check authorization files, and the ability to store and forward files to the ISP 110.

Automatic recovery of the ISP 110 and the terminals 124/workstations 126 from an off-line situation is preferably supported by the POS system 108. A supervisor typically has visibility through a report or other means to determine which POS terminals 124 have transmitted offline totals to the ISP 110. All off-line occurrences are preferably logged and transmitted to Host 112.

The ISP 110 is preferably fully redundant and provides back up capability for all store files, including, the PLU file, Express Customer file, Check Authorization File, Electronic Journal File, Data Collect File, maintenance files, POS terminal/workstation application files and any other appropriate data files The computerized POS system 108 depicted in FIG. 1 preferably utilizes RDBMS technology with record layouts, file formats and report capabilities that may be readily enhanced for future applications without major coding changes. In the preferred embodiment, application programs are programmable in an easily portable ANSI standard language. Likewise the operating system is industry standard and preferably state-of-the-art.

File Maintenance

The POS system 108 of FIG. 2 also allows for Immediate File Maintenance including the ability to add, change or delete individual records in the POS system files. All file modifications done in “immediate maintenance” will update the files at the store ISP 10 immediately after they are completed and automatically download the changes to the POS terminals 124, if applicable. Any and all maintenance applied to the files is captured by the POS system 108 and uploaded to the Host 112 during end-of-day polling/processing.

Likewise, the POS system 108 of FIG. 2 also allows for remote Host 112 maintenance including the ability to apply immediate maintenance remotely from the Host 112. All modifications received from Host 112 will be applied to the ISP 110 and automatically downloaded to the POS terminals 124 if applicable as soon as they are received. Maintenance may consist of individual records for individual files or entire batch transmissions. Preferably “real time” maintenance, rather than batch maintenance is utilized by the computer system of the present invention. The POS system 108 of FIG. 2 also provides the ability to set an “apply batch date/time” so that batches are not be applied until the designated “apply date.” Maintenance can thus be applied as a batch received from the Host and store files updated during nightly processing. Preferably personnel at each retail store can review and approve batch maintenance before it is applied.

Any and all maintenance performed at the store level is captured in a log and uploaded to Host 112 during nightly polling/processing including applied batches or immediate updates applied to the system. Any price changes performed are written to a local file logging the PLU Number, Description, and a “snapshot” of the record before changes were made and after changes were made. File changes are viewable at the store level as well as remotely from host. Likewise, any previously applied maintenance whether it was performed at store level or downloaded from the Host is reversible. Reversals (from host or at store level) are also logged.

In the preferred embodiment, running transaction totals are also available at all times. The operator display is fully configurable within the application software to define which totals will be displayed during the transaction. The ability to display operator prompts, error and informational messages at required time(s) is supported by the POS terminals 124 of the present invention. Likewise the ability to fully customize operator prompts and messages by terminal is supported. As noted above, the POS terminal's 124 display has multi-media capability, to provide for the display of flip charts, or PLU charts, graphics and full motion video.

Functional Features Of The POS Terminal 124

I. Cashier Prompts

The preferred embodiment of the POS terminals 124 also includes a single terminal directly wired to, and supporting, both a customer display and a cashier display such that the two displays are fully interactive on a real time basis. Additionally, the POS terminal may have a special function key, or software switch, to allow the cashier to take control of the customer display, thus enabling the cashier to assist the customer without having to step onto the other side of the counter.

The POS terminal also includes Cashier Prompt capability. All operator prompts and messages, whether printed or displayed, are fully and easily customizable via the application software. Cashier prompts are variable and changeable, depending on the POS terminal/supervisor workstation function. Cashier prompts do not show on the customer display 128. The idle message between transactions prompts the cashier to scan or enter the customer's Express Number as will be more fully described below. If the customer does not have a Customer Card, the cashier bypasses the prompt with a single key stroke and begins normal item entry.

The POS terminal 124 also has the capability to broadcast messages to a single cashier or all cashiers. Messages to cashiers may be generated from the Host, 112 or the ISP 110 by a store supervisor. A cashier can also send a message to a supervisor terminal. In the preferred embodiment messages do not interrupt a cashier/operator during a transaction but are displayed or retrieved only between transactions. Like cashier prompts, cashier messages do not show up on the customer display 128.

II. Function Keys of the POS terminal

The POS terminals 124 of the preferred embodiment are easy to learn and use, and contain Help screens or displays to lead the operator through particular processes.

Typical function keys on the POS terminal 124 are given in Table 1 below.

TABLE 1

| KEY | FUNCTION |
|---|---|
| ENTER | Allows cashier/operator to enter information input on a |
| | line item basis or execute a command given to the |
| | terminal. |
| CLEAR | Allows cashier/operator to clear information input at |
| | the line item level, prior to pressing the <Enter> key. |
| | Also used to clear select error messages generated by the |
| | terminal/workstation or a POS peripheral. |
| BACKSPACE | The back space key clears the last character entered. |
| QUANTITY | Used to enter a quantity within a line item. A quantity of |
| | 1″ is assumed if an alternate quantity is not entered. |
| @/FOR | Used to distinguish item quantities when entering deal |
| | pricing (not handled by the PLU file) or split package |
| | pricing. For example: 2 <quantity> @ 3 <for> $4.00 |
| PRICE CHECK | Used to display an item price from the price file. |
| OVERRIDE | Used to “override” the price of an item as listed on the |
| | price file to allow entry of a different price. Typically |
| | requires supervisor authorization. |
| NO SALE | Used to open the cash drawer without being in the |
| | tender cycle of a transaction. Typically requires |
| | supervisor authorization. |
| RETURN | Used to return the purchase price of a previously |
| | purchased item. This function typically requires entry of |
| | a reason it code. |
| RAIN CHECK | Used to generate a rain check for items currently out of |
| | stock. |
| BOTTLE DEPOSIT | Used to identify a bottle deposit charge to the customer. |
| | This function could also be handled via the |
| | application/PLU record, providing the system allows. |
| BOTTLE REFUND | Used to identify a bottle deposit being refunded to the |
| | customer. |
| PRICE LOOK-UP | Used to key in pre-programmed numbers for certain |
| (PLU) KEY | items. Example: produce items, bakery items, etc. |
| REFUND | Used for refund of item(s) previously purchased. |
| | <Refund> is used for items that cannot be put back on |
| | the shelf. |
| VENDOR COUPON | Used for vendor coupons that do not have scan bars. |
| | Must have the optional capability of automatically |
| | multiplying a coupon value. |
| STORE COUPON | Currently used to record items being purchased with a |
| | raincheck. Also used to adjust the price of an item |
| | purchased under the Express program that did not ring |
| | correctly. Must be able to enter into the appropriate |
| | department. |
| DO NOT DOUBLE | Used to manually prohibit multiplying the face value of |
| (coupon) | a coupon. |
| CLOSE/LOCK | Used to lock the POS terminal with a single key stroke. |
| | Also used as terminator key for the unlock procedure. |
| SUSPEND/RESUME | Used to Suspend a transaction and/or Resume a |
| | previously suspended transaction. |
| RECEIPT ADVANCE | Used to advance the receipt paper from the keyboard. |
| ITEM VOID | Used to void an item during the transaction that was |
| | previously entered. |
| ERROR CORRECT | Used to delete the last item entered. |
| SUBTOTAL | Used to Subtotal a transaction. |
| TOTAL | Used to Total the transaction. |
| TENDER | Used to invoke Tender Cycle for the transaction. |
| SCALEITARE | Used to weigh an item without a tare attached. ex. If a |
| | cashier needs to manually ring in a meat item. Also |
| | currently used to record weighted |
| | items in an off-line mode. |
| TAX EXEMPT | Used to make the transaction exempt from taxation. |
| PLU SELECT | Allows the manual entry of a UPC code that begins with |
| | an NSC other than zero. |
| CASH CHECK | Used as a media exchange key outside of a sale |
| OUTSIDE ORDER | transaction. Typically used for check cashing. |
| MISC. CODED MEDIA | Used as a coded tender key to (customizable) |
| KEY | distinguish different tender medias being used. |
| CONSUMER PANELIST | Used to identify a customer as an Information Resources |
| | (IRI) panelist. Customer presents card which is scanned |
| | or key entered. |
| EXTRA SAVINGS | Used if manufacturer coupon is scanned or key entered |
| | to give an extra discount. |
| MINIMUM OF 2 TAX | Used to modify tax by line item and as a toggle to |
| MODIFIER | change taxable/nontaxable item status. |

POS Terminal Modes

The POS terminal 124 of the present invention preferably supports various terminal modes including the following:

i. Check-Out Mode used to process customer transactions at various locations throughout the store. Check out mode is provided in various terminal configurations, as indicated

ii. Supervisory Mode used to execute supervisory functions, as defined below.

iii. Training Mode Used to train store personnel on POS Terminal operations. The Training Mode emulates the POS application, allowing the trainee to fully train on the system without affecting any Store Totals. Any transactions done in Training Mode is clearly identified on the Receipt. (i.e., TRAINING TRANSACTION-NOT A VALID RECEIPT.)

iv. Monitor Mode Used for security purposes to monitor a cashier during transaction entry. Monitor Mode allows the supervisor to view the Electronic Journal File (see below) in real time for the terminal being monitored. The ability to interface Monitor Mode with in-store security cameras is preferred, as well as the ability to capture data and to generate ‘exception reports’.

POS Terminal Functions in Check-Out Mode

When in the check-out mode, the following functional requirements are provided by the POS terminal 124:

i. Cashier sign-on and sign-off procedures are standard for all operators on all terminals. Cashier sign-on requires entry of a minimum two (2) or three (3) digit (customizable) cashier number and a minimum two (2) digit secret code (password). The cashier secret code is preferably established the first time and every time a cashier signs on for the week. The cashiers' secret number is automatically reset as a component of the cashier totals resetting and settling (cashier totals are typically reset and settled weekly). The cashier secret number may be reset manually, separate from the cashier totals reset.

The cashier personal code is never displayed or printed. Personal codes are considered secure and even supervisors do not have access to the cashier personal codes unless they have a specified security level. The Host (remote) however has the ability to view operator secret numbers.

The system should support the ability to verify that the cashier signing on is scheduled for that date and time as an optional feature. A supervisor override is required to allow cashiers to sign-on if they are not scheduled.

ii. Terminal Lock and Unlock functions allows a cashier to lock and unlock a terminal/workstation via the application. For security reasons, the terminal/workstation is preferably locked and unlocked by the same cashier. A supervisory override procedure for a locked terminal/workstation is available in the event that the cashier that locked the terminal becomes unavailable.

A terminal/workstation that has not been used in a specified amount of time is automatically locked. The time limit is definable and changeable by store personnel with the ability to set individual “auto-lock” times for individual terminals. Additionally, the POS terminal 124 preferably can automatically lock a terminal based on a time schedule as determined in the application.

iii. The POS terminal 124 preferably supports a minimum of 20 Itemizers, customized by store personnel.

iv. The POS terminal 124 supports PLU item numbers, according to UCC guidelines.

v. The POS terminal 124 supports the following Universal Product Code (UPC) types:

1. NSC 0 Version-E (regular items)

2. NSC 2 (variable weight)

3. NSC 3 (drug/health products)

4. NSC 4 (in-store numbers)

5. NSC 5 (vendor coupons)

6. NSC 0,6,7 (regular items)

7. NSC 21 (weight in code)

8. NSC 22 (price in code)

The POS terminal 124 also supports European Article Codes (EAN).

vi. The POS terminal 124 also allows an item to be scanned or key entered with a price that is different from the one on the PLU file. The difference between the price entered and the price on the PLU file is included in the savings discount amount printed on the customer receipt as well as updated in the applicable totals being maintained by the store system. The price override procedure is data collected. Supervisor authorization requirements may apply.

The entry of a Price Override follows the logical flow of the item entry process. (i.e., 1. Scan the Item; 2. Enter the price of the item; 3. Index the <Price Override>key

vii. Itemizer Override. The POS terminal 124 includes a method to allow the operator to override the default Itemizers affected by a particular item.

viii. Visual Verify. The PLU record preferably has a flag to tell the system that the price on this item must be verified. After the operator enters the item, the system displays the price from the PLU file and prompt the operator to verify the price of the item. The operator has the ability to enter a different price and press <Enter>or simply press <Enter>and accept the price from the PLU file. The POS terminal 124 preferably does not allow the cashier to enter a price higher than the current price in the PLU file, without supervisor override.

ix. Scan Accuracy is the ability to alert a designated manager workstation in the store that a Scan Error has occurred.

x. Quantity Required Flag. The PLU record has a flag that will cause the operator to enter a quantity before entering the item.

xi. Quantity Prohibited Flag. The PLU record preferably has a flag that will not allow the operator to enter a quantity before entering the item.

xii. Mix & Match Codes. The POS terminal 124 allows for package pricing over a mixture of different PLU items.

xiii. Credit Item. The PLU record has a flag to tell the system that this item should be sold as a credit item. This may be a store coupon, bottle return, or other type of credit item.

xiv. Age Validation. This function is typically used for the sale of controlled substances such as alcohol, cigarettes, etc. The PLU record has a field to indicate that this item must prompt the cashier to verify the age of the customer before purchasing the item. The cashier prompt message is based on the PLU number and definable by the store. The POS prompts only one time per transaction, the first time a controlled item is entered.

xv. Link Item. The POS terminal 124 has the ability to automatically process a second PLU item that is linked to the original item entered by the operator. This link item can be either a positive or negative item. For example; this link item may be a bottle deposit or it may be an automatic coupon. The POS preferably can support multiple levels of links (i.e., be able to link a link to a second link to a third link, etc.).

xvi. Item Not On File. The POS terminal 124 has the ability to capture and store information any time an item is scanned and it is not on file. The system should allow the cashier to enter the price of the item and the description. The option of broadcasting “Not On File” messages to a Scanning Coordinator's workstation is also supported. “Not On File” incidents are preferably available in report format, with full item detail, for review by the Scanning Coordinator or store management. Additionally, it the system provides the ability to generate an “Item Not On File” slip at the POS. The printing of this slip should be either automatic at the end of the transaction or printed on command by the cashier. Whether a slip prints automatically or on command is definable in the POS application. Items that scan as “Not On File” are data collected for host retrieval.

xvii. Recalled Item Flag. A PLU record can be flagged to prohibit the sale of an item that has been recalled. If a recalled item is entered/scanned, a message display alerts the cashier that this item has been recalled and cannot be sold.

xviii. Price File Requirements. The POS system supports all of the field requirements of the PLU File defined above.

The POS terminals 124 of the present invention also have the following features and entry methods available for entering an item during checkout.

i. Scanner Entry. The ability to scan any of the required UPC label types, as defined above is included in the preferred embodiment. The system is able to display and/or print any and/or all of the item detail as defined in the item record including PLU/UPC number, description, department, quantity, and price/package price.

ii. Manual UPC/PLU Entry. An alternate method of entering a UPC code or PLU number if the label cannot be read by the scanner is also preferably provided. The system should then be able to display and/or print any and/or all of the item detail as defined in the item record including PLU/UPC number, description, department, quantity, and price/package price.

iii. Restrict Sale By Date/Time The POS terminal 124 also included the ability to restrict the sale of an item by date, day of the week or time of day. This feature is used primarily for the following purposes:

a. To act as a control for alcohol sales to stop sales during prohibited times.

b. To put an item on sale but restrict it to a specific time frame.e.g.,

Restrict to date-MM/DDNYNY format

Restrict to day of week (Sunday-Saturday)

Restrict to time of day-HH:MM format

The ability to restrict the sale of an item based on the day of the week or the time of day should is user-defined in the UPC record.

iv. Preset PLU Keys. The POS terminal 124 provides the ability to pre-set designated keys on the keyboard which are identified with a single PLU or UPC. This key is typically used to enter high frequency items with a consistent price point (i.e., newspapers). The preset keys are preferably inter-changeable, programmable and customizable for any and all keyboard types and keyboard layouts.

v. Fixed Department Key. The POS terminal 124 also provides the ability to set-up fixed department keys on the keyboard. This allows a single key on the keyboard to be associated with a specific department (e.g. grocery, meat, produce, etc.).

vi. Non-Fixed Department Entry. The POS terminal 124 also allows a cashier to enter an amount into a department which does not have a pre-set department key defined on the keyboard. The department number entered must be defined in the system or the entry will not be allowed.

vii. Scale/Weight Item Entry When the item is placed on the scale and the PLU number scanned/entered, the actual selling price of the item, based on weight is automatically calculated.

The price per unit of weight for an item is preferably resident in the PLU file along with tare weight. The POS system 108 of the present invention preferably allows for manual entry of an item's weight as well as tare weight. The ability to support a variable tare within each PLUMPC record is required. The system should also support fixed tare for pre-packaged goods.

The POS system preferably has the ability to track and report the total number of pounds sold (by UPC/PLU number) as an end-of-day report or as a periodic report (weekly, monthly, etc.)

viii. Entitlement Program Item Entry. The POS system 108 of the present invention also includes the ability to identify and verify authorized items for government entitlement programs such as the Womens Infant & Children (WIC Program). For example, a WIC customer may buy a 14 oz. cereal but the 10 oz cereal is specified on the WIC check. The WIC total is preferably available for display to the cashier and the customer as well as receipt printing.

Additional Pricing Features

In addition to item base pricing, the POS system 108 of the present invention also supports the certain other pricing features including:

i. the ability to buffer “same PLU” items recorded in the order and print a collective total saving for those items;

ii. Sale Price by Year, Date and Time to provide sale price control, including sale price stop and start (date and time) and item tracking;

iii. Split Package Pricing to track all items participating in a package or deal pricing structure and give the correct “package/deal” price after the required package quantity is met, including the ability to data collect sales of items that do not meet the Full Split Package Price. (e.g., data collect if customer buys 1 item of a 2/$1.00 package); and

iv. Line Item Discounts as either a percentage off of the line item price or a fixed amount deducted from the line item price. Line item discounts preferably have the ability to be pre-set in the PLU record or manually entered by the cashier with a supervisor override. In the event a “discounted” line item is voided or error corrected, the POS system automatically adjusts any discounts applied to that item. The ability to include each line item discount amount in the “savings message” on the customer receipt is preferably available as an option.

Other pricing features preferably supported by the POS system 108 of the present invention include the ability to support a department level discount to an individual department, a group of departments or a group of items, if configured in the PLU file (described below.). Any time an item in the participating department is entered, the discount is automatically applied. The manual entry of a Department or Department Group Discount by a cashier is also allowed, provided the cashier is prompted by an override condition. In the event a “discounted” line item, participating in a Department or Group Department Discount, is voided or error corrected, the system automatically adjusts any discounts applied to that item. The ability to include group discount amounts in the “savings message” on the customer receipt is preferably available as an option with supervisor override capability.

Merchandise departments are also able to enter markdowns for short coded or damaged product. This information is available for transmission to the host computer 12 as well as available in report form at the store. The new retail prices, after markdowns, for on-hand inventory will be used to cost the inventory for financial reporting purposes.

Additionally, in the preferred embodiment the POS system 108 provides for the following pricing features:

1. Require multiple purchase of 1 item or multiple purchases of several different items.

2. Require purchase of a minimum weight for a particular item.

3. Require purchase of a minimum dollar amount.

These options are preferably customized to allow tracking of totals by department or by total order.

Transaction Level Discounts, in which a discount is applied against an entire transaction, are also supported by the POS system 108 of the present invention. Transaction Level Discount are preferably allowed at any time during the transaction and may be manually entered or preset as a percentage of a fixed dollar amount. Cashiers have the override capability to allow the amount of percentages of discount to be changed during a transaction. Item record and department validation of discount eligibility is typically required to ensure that all items entered are eligible for the transaction discount. If not, the discount is applied only to those items that are eligible. The discount amount is then printed on the receipt.

Transaction discount and promotional activities within a transaction discount are captured and reported by total discount amount with tracking and reporting capabilities definable by the store.

For each of the foregoing discount options the POS system preferably includes the ability to require a Supervisor Override.

Bottle Deposits

Another feature of the POS system 108 of the present invention specific to the modern supermarket relates to bottle/can deposits. Bottle deposits are typically collected at the register when the customer purchases a bottle or canned beverage. The bottle/can deposit is programmed to be accumulated into bottle deposit totals. When bottles are returned, the customer deposits the bottles or cans into a bottle/can crushing machine and receives a slip with the amount of the refund printed on it. The customer presents the bottle refund slip to the cashier at the point of sale for a refund/credit towards purchases. The POS terminal 124 of the present invention prompt for cancellation endorsement of the bottle refund slip. This endorsement is preferably customizable by each store. The POS system also provides the ability to track empty container refunds and report upon request. It also provides the ability to credit a customer's account or Customer Card for the amount of the refund. The credit is stored in the Customer record at the host and applied against the next purchase recorded at the POS terminal 124.

Error Correction, Void and Transaction Cancellation

The POS system 108 of the present invention also provides error correction, void and transaction cancellation procedures. Such procedures include ‘line item error correct’ which voids the last item entered in the transaction. This procedure is preferably accomplished with a minimum number of key strokes and can be performed without having to reenter the item being corrected. The total count and amount of error corrects is preferably tracked by the POS system and reported on a store basis and by each cashier/operator and includes the capability to set a maximum dollar amount allowed for line item error correct without a supervisor override.

Item Void allows any item including tenders to be voided at any time during the transaction. This function can only be performed within the transaction and the system must validate that the item being voided was previously entered by the cashier. It also includes the ability to set a maximum dollar amount allowed for Item Void without a supervisor override. The total count and amount of item voids is also tracked by the system and reported on a store basis as well as by each operator. Optionally, the system supports the ability to print on a void slip and suppress the printing of item voids on the customer receipt.

Transaction cancellation is also a function of the preferred embodiment of the POS system 108 of present invention. Transaction cancellation provides the ability for an operator to terminate a transaction at any time during the transaction. Terminated transactions are handled in the same manner as an item void in that financial totals or inventory information will not be updated in the system. The system generates a receipt slip that clearly identifies that the transaction was terminated. If a transaction is terminated for any reason, the receipt preferably show and print all of the items that were entered in the terminated order and clearly indicate that the order was terminated. The ability to require a supervisor override for Terminated Transactions is preferably supported. The POS system also tracks the total count and amount of terminated transactions on a store basis and for each operator.

Lastly, a transaction that was previously completed may be voided at any terminal but preferably within the same business day. The system preferably has the ability to retrieve the original transaction from the Electronic Journal and set a voided flag within it. All totals files and merchandise files are updated accordingly. Included in this function is the ability to track and report on void previous transactions by store, original cashier and operator performing the void. As above, the ability to require a supervisor override for void previous transactions is preferably supported.

Tax Handling

The POS system 108 of the present invention preferably supports a minimum of six tax tables with the ability to assign items to multiple tax tables where appropriate. The ability to individually print (on the customer receipt) multiple tax accumulators within a transaction is a feature of the preferred embodiment. Tax features supported by the POS system of the present invention include the following:

i. Taxable/Non-Taxable Toggle

This feature allows the cashier to use the <TAX>key toggle switch for an individual item. If the item is normally taxable, then the <TAX>Itemizer will make this item non-taxable. If the item is normally non-taxable. Then the tax Iternizer will make this item taxable.

ii. Percentage Item Tax

This feature provides the ability to tax only a percentage of the item selling price. The percentage is preferably an adjustable field for each item.

iii. Manual Tax Entry

This feature provides the ability to manually enter tax for an individual line item or for an entire transaction.

iv. Tax by POS Location

This feature provides the ability to tax an item based on the location of the POS workstation in the store.

v. Tax By Number of Items Purchased

This feature provides the ability to tax an item based on the number of items sold within that transaction. This feature is typically used in food service depending on whether an item is being purchased for consumption on or off premises.

vi. Food Stamp Tax Exempt Food Stamp Eligible Items Are Tax Exempt By Law.

Taxable items approved for purchase with food stamps are to be exempted from taxation when the transaction is tendered with food stamps.

vii. Tax Exempt Transaction.

Select transactions are tax exempt (e.g., charity, diplomatic status, resale, etc.). The POS system 108 preferably has the ability to prompt for entry of a tax exempt number if the transaction is to be recorded as Tax Exempt. The cashier has the option of reversing the tax exempt status of a transaction (within the transaction) if this function was invoked in error. In this event, the transaction would follow normal taxation routine.

Transaction Subtotal and Totals

In the preferred embodiment, the POS system 108 has the ability to display on the cashier/customer monitor(s) a running subtotal of the current transaction, including any discounts or credits applied. Additionally, the system provides the ability to display and print on the customer receipt, alternate subtotals such as food stamp subtotal, taxable subtotals and any other Itemizer totals that are defined in the system. Subtotals to be displayed or printed are definable within the application and include any discounts applied, triple coupons redeemed or points redeemed.

The transaction total amount displayed when the total key is pressed preferably reflects all items recorded, applicable taxes, and all credits/discounts applied. This total is also printed on the receipt at finalization.

System Totals

In addition to individual transaction totals, the POS system 108 of the present invention provides the ability for the retail store to fully customize all Totals tracked, maintained and reported by the system. By this, it is meant the ability to determine exactly what is factored into a totals accumulator, exactly how calculated totals are derived and the type/layout of required reports.

Unique accounting periods can be established for each type of Totals maintained by the system. An accounting period could be a day, week, month, year or any other time period as designated by the retail store. Totals accumulated for a specific period remain in effect until that specific period is reset. Totals from one period may be rolled into the next period's totals only at the time of reset and only if configured to do so in the application.

The POS system 108 of the present invention supports at least the following Store Totals. Store Totals are typically maintained for each accounting period assigned to that specific Total type.

| | TOTALS ACCUMULATION |
|---|---|
| TOTALS TYPE | REQUIREMENTS |
| Gross Group | Gross Group totals are comprised of two |
| (all transaction | elements, Current Gross Group and Starting |
| receipts) | Gross Group. Current Gross Group totals minus |
| | Starting Gross Group totals should equal Gross |
| | Sales. |
| Gross Sales | A total of all transactions rung into the system |
| | including all training gross, canceled |
| | transactions, voids of sales, Express savings |
| | totals, other income, etc. |
| Adjusted Gross Sales | Gross sales minus training gross, canceled |
| (gross receipts) | transactions, voids of sales and tax credits. |
| Refunds/Returns | Accumulates all negative amounts generated as a |
| | result of returns or refunds entered into the |
| | system, for the specific period. |
| Error Correct Void | Accumulates a total for all Error Corrects, Voids |
| Terminated Trans- | and Terminated Transactions entered into the |
| action Totals | system, for the specific period. The system tracks |
| | the number of Error Corrects, Voids and |
| | Terminated Transactions performed along with |
| | individual amounts, for the specified period. |
| Credits/Discounts/ | Accumulates all credits entered into the system |
| Coupons | for the specific period such as Coupons applied, |
| | Discounts, Markdowns, Customer Rewards, etc. |
| | The system tracks the number of credits by credit |
| | type and accumulated amounts by credit type for |
| | the specified period. |
| Net Sales | Equals adjusted gross sales minus bottle refunds, |
| | Express Customer totals, in store coupon totals, |
| | refunds, returns, other income, meals tax and |
| | sales tax. |
| Memo Totals | Memo Totals to track “nonfinancial” totals such |
| | as no sales performed, audits, etc., for the |
| | specified period. |
| Tax | Accumulates the amount of tax collected by the |
| | system, including sales and meals tax, for the |
| | specified period. The ability to individually track |
| | and report multiple tax type(s) accumulation and |
| | refund, if desired, is also supported. |
| Tender Totals | Accumulates and reports all tender totals by |
| | individual tender type and count, if applicable. |
| Item Sales By Day | Accumulates item sales by Day and by Week |
| and Week | with the ability to report on either. |
| Express Savings Totals | Accumulates all Express Savings discount totals. |
| Average Price Per | Net sales total divided by the item count equals |
| Item Totals | the average price per item sold. |
| Customer Count | Total of all transactions excluding coupons taken |
| | off outside of an order, all paid out totals and all |
| | miscellaneous total orders. The ability to track |
| | and report, if desired. |
| Average Sale Per | Total net sales divided by the customer count. |
| Customer | |
| Points Earned | Total of all points earned for the specified period. |
| Points Redeemed | Total of all points redeemed for the specified |
| | period. |
| Receipts and Deposits | Total of media affecting safe totals, that are |
| | receipted into and/or decremented from the |
| | system with the Ability to track individually. |
| Media On-Hand | Total of all media on-hand for entire store |
| | including safe totals, cashier/operator drawer |
| | totals. This figure is not updated until end of day |
| | processing. Resets during end of day processing. |
| Overages/Shortages | Ability to calculate/track overages and shortages |
| | for cashier/operator and by safe for specified |
| | periods and as a cumulative total. |

With the exception of Non-Resettable Gross Totals, accumulated Cashier/Operator Totals follow the same format as Store Totals above. Operator Totals are tracked/reported as follows:

1. SALES ACCOUNTABILITY

Gross Sales

Canceled Transactions

Voids of Sales

Tax Credits

2. ADJUSTED SALES ACCOUNTABILITY

Loans

Pick-Ups

Non-Cash Refunds

Tender Media

Manufacturer Coupon

Total Coupon

Bottle Refund

Paid Out Total

Express Savings Club

Refund

Return

Store Coupon

Total Discount

3. ACCOUNTABILITY BY MEDIA TYPE

4. MEMO INFORMATION includes Item Count, Dollar Value of Overrides, Credit Voids, Voids, Error Corrects, No Sale, Counts Customer, Count Time Open/Unlocked, Sales Per Hour, and Item Count Items Per Minute for example.

5. SALES CATEGORIES Includes Department % and Department Total Voids and Total Less Voids

Department Totals are also supported by the POS system 108 of the present invention. All totals must be maintained and/or reportable for each accounting period assigned to that specific total type. Department totals are typically kept by each department and sub-departments associated with a specific department and include the following types:

| | TOTALS ACCUMULATION |
|---|---|
| TOTALS TYPE | REQUIREMENTS |
| Gross Dept. Sales | Accumulates, by department and sub- |
| Total | department, all positive amounts entered into the |
| | system, for the specified period. |
| Total Discounts/ | Accumulates, by department and associated |
| Credits | sub-department, all discounts and credits |
| | applied against a specific department with the |
| | exception of Express Savings discounts and |
| | Coupons. Includes the ability to track and report |
| | discounts and credits by discount/credit type. |
| Express Savings Dis- | Accumulates all discounts generated by Express |
| counts | Savings and applied against each |
| | department/sub-department. |
| Coupons | Accumulates all Store and Manufacturer |
| | Coupons applied against each department/ |
| | subdepartment. Includes individual breakdown |
| | by store and manufacturer and ability to track % |
| | of manufacturer coupons key entered, by |
| | department. |
| Refunds and Returns | Accumulates all refunds and returns applied |
| | against each department. Includes the ability to |
| | track the number and types of refund/return by |
| | department. |
| Voids/Transaction | Accumulates the total number and amount of |
| Termination | Voids and Transaction Terminations performed |
| | for each department/sub-department. Voids and |
| | Transaction Terminations are reported as a sum |
| | total or individually. |
| Error Corrects | Accumulates the total number and amount of |
| | Error Corrects performed for each department/ |
| | sub-department. |
| Net Department Sales | Adjusted Gross Department sales minus bottle |
| | refunds, Express customer totals, in store coupon |
| | totals, refunds, returns, other income, meals tax, |
| | and sales tax. |
| Misc. Income | Accumulates all non-sales income by income |
| | type/department. Example: Money Order Sales, |
| | Western Union Sales, Lottery, etc. Accumulates |
| | totals for all non-sale items paid out of the |
| | system by type/department. Example: Lottery, |
| | donations, etc. |
| Miscellaneous Paid- | |
| Out | |
| Department % of Store | Calculated on NET Department Sales divided by |
| Sales | Total Store Net Sales. Accumulates the total |
| | items sold for each department, for the specified |
| | period. As a subset of total items sold, includes |
| | the ability to track the total number of Items sold |
| | at sale price and the total number of items sold at |
| | regular price. |
| Total Items Sold | |

In addition to store, cashier and department totals, the POS system 108 of the present invention also supports productivity totals. Productivity totals are typically maintained for both the operator and the store and include the ability to track and report productivity by lane number and/or lane type (express lane, courtesy booth, regular lane perimeter departments, etc.) and the ability to generate summary totals. In the preferred embodiment of the present invention, Productivity Totals include the following:

| TOTALS TYPE | TOTALS ACCUMULATION |
|---|---|
| Sales Volume Per | Calculates the Sales Volume per Hour for each |
| Hour | Cashier/Operator and for the Total Store, by |
| | specified period. |
| Number Items Sold | Calculates the Total Number of Items Sold Per |
| Per Hour | Hour for each Cashier/Operator and for the |
| | Total Store, by specified period. |
| Number Customer Per | Calculates the Total Number of Customers Per |
| Hour | Hour for each Cashier/Operator and for the |
| | Total Store, by specified period. |
| Scan Percentage | Calculate the Scan Percentage Rate for each |
| | Cashier/Operator and for the Total Store, by |
| | specified period. |
| Key Entered Percen- | Calculates the Percentage of Items Key Entered |
| tage | for each Cashier/Operator and for the Total |
| | Store, by specified period. |
| Scan Coupon Percen- | Calculates the scan % of manufacturer coupons. |
| tage | Ability to report breakdown by department and |
| | grand total is included in addition to ability to |
| | report by individual cashier/operator. |
| Key Entered Coupon | Calculates the % of manufacturer coupons that |
| Percentage | were key entered. Ability to report breakdown |
| | by department and grand total is included in |
| | addition to ability to report by individual |
| | cashier/operator. |

Tender Types

The POS system 108 of the present invention preferably supports at least 40 different tender types and two (2) foreign currencies and includes the ability to establish a specific set of operating characteristics and options by tender type. Additionally, the ability to define how a tender will function within specific transaction types is also supported. Each tender mat be voided at any time during the transaction sequence.

Multiple tenders are preferably allowed within a transaction with the ability to pre-set the order in which tenders are entered (e.g., credit cards typically tendered last). The POS system 108 allows tenders to be entered until the transaction total is equal or exceeded. The ability to re-enter the item entry cycle after tendering has been initiated is also supported. Printing and output of all tendered information is held until the final tender is accepted.

The following Tender Types and Requirements are supported by the preferred embodiment of the present invention.

1. Cash

Cash is supported by a <CASH>key. The ability to require Supervisor Override on amounts above a supervisor halo (parameterized) is also supported.

2. Checks

The following check types are preferably supported by the POS System of the present invention:

Personal

Payroll

Welfare and Government

Western Union

Company

Travelers Checks

Manufacturer Rebate

All check types require the entry of an account number. The account number may be obtained by scanning the Customer card or inputting the account number from the check into the POS terminal 124. The system preferably interfaces to a Magnetic Ink Character Recognition (MICR) reader for electronic entry of the account number or manual entry of the account number, via the keyboard, by the cashier/operator. In the preferred embodiment all of the following features are supported for check tenders:

The ability to prompt for identification, based on check type and whether or not the customer has an Express Card.

The ability to encode checks accepted at the stores when the register is printing the endorsement on the check (MICR read and write capability).

The ability to validate the check against an in-store negative check file. If a check number is found on the negative check file, the system must have the ability to alert the cashier using an alpha/numeric response message that is fully definable by the retail store. Based on the message, several different actions may be required (e.g., see ID, call for supervisor override, etc.). Supervisor override options are preferably definable.

The ability to access the remote check authorization file.

The ability to accept an alternate ID (SSN#, drivers license #, etc.) and pass the ID to a remote host which in turn would send back the Express Shopper number with a positive or negative response.

The ability to interface with a Loss Prevention organization's bad check file, to access bad check amount and associated fee information to facilitate customers making bad check payments at the store courtesy booth.

The ability to utilize the receipt printer to print the front of the check for the customer including the date, the amount (both written and in numeric notation), and the ‘pay to the order of’. The customer should only have to sign the check.

The ability to print a validation and endorsement on the back of all checks. Endorsements are preferably customizable for each store.

The ability to set control limits for checks such as the ability to track the number and total amount of checks cashed using the same Express Customer Card number in the same day and for specified periods. The ability to limit the number of checks and the total amount in a day and the number of checks and the total amount in the specified period is also preferably supported.

3. Food Stamp/WIC Special Handling

The POS system 108 provides the ability to accept WIC Checks at the register including the ability to print the amount on the check by the POS terminal 124, eliminating the need for cashier's to write the amount on the face of the check.

The POS system 108 also provides the ability to handle EBT's (electronic bank transfers) for entitlements. EBT is currently being defined by the Northeast Coalition. This coalition consists of every New England State as well as New York. An EBT standard is defined in the Northeast Coalition publication IS08583 EBT Guidelines. Preferably, the POS system meets the guidelines set forth by this coalition.

4. Credit Cards

The POS system 108 of the present invention also handles all standard credit cards currently in use including the store co-branded card if applicable. Credit card types are typically recognizable based on the first “X” high-order digits of the account number, when the credit card is swiped through the Mag Stripe Reader (MSR) or the account number is key entered by the cashier. The POS system supports at least the following:

The ability to read tracks 1, 2 and 3 on the card, as applicable. The credit card number must pass Check Digit Validation (CDV) as soon as the account number is read/input.

If the credit card number is manually entered or the expiration date cannot be retrieved from the credit card via the MSR, the cashier is prompted for entry of the expiration date. The expiration date is validated against the system date to ensure it has not expired.

The ability to create an authorization record, based on authorizer requirements, at the ISP and forward the credit card transaction for authorization.

The ability to establish and maintain an authorization table at the ISP for processing of returned authorization codes. The response determines what type of action is required for the Credit Card (e.g., “Good-Complete Transaction”, “See Second ID”, “Supervisor Intervention Required”, “Auto-Void”, etc. All messages forwarded to cashiers, in an easily understood and human readable format, and all required actions based on return code are preferably definable.

The ability to set limits for both on-line and off-line credit transactions. These limits determine if the credit card can be accepted without requiring remote authorization. All credit authorization activities occurring in an off-line situation should be captured and transmitted to host when communications are restored.

The ability to reconcile totals on-line with credit/debit processor.

5. Customer Charge

The POS system 108 preferably supports the ability to handle customer charge tender on a select basis. This type of charge does not refer to a Co-Branded Card. Certain organizations, such as schools, churches, etc., are authorized to charge purchases. The same authorization and print requirements as standard charge transactions typically apply for charges. The system also supports the ability to restrict this tender function at specific terminals as defined by the store.

In another embodiment of the customer charge, the customer's customer number functions as a charge account number with PIN number entry. Transaction processing follows the same routine as a debit card (see below). This embodiment eliminates the need to print a charge signature receipt.

6. Debit Cards

The POS system 108 of the present invention also supports debit cards as a tender type, and is able to utilize a variety of authorization networks. Debit card terminals used may be NTN, NCR or Attalla for example. The debit card function preferably supports at least the following:

The ability for the Debit Card to be read via an integrated PIN pad/MSR device.

The ability to allow the card to be “swiped” through the IVISR at any time during the transaction.

If an amount is tendered with a debit key, the system prompts the customer to enter their PIN number using the PIN pad. The system also supports the ability for the PIN number to be entered any time during the transaction.

The cashier has the ability to enter the amount to be authorized against the debit card with confirmation from the customer. The system preferably supports the ability to enter amounts greater than the amount due. The ability to set “cash back” limits for debit cards is also supported.

The ability to establish and maintain an authorization table at the ISP for processing of return authorization codes. The response will determine what type of action is required for the Debit Card (e.g., “Good-Complete Transaction”, “Unable to Authorize-Request Another Tender Type, etc.). Preferably all messages are forwarded to cashiers and all required actions based on return code are definable.

The ability to reconcile totals on-line with credit/debit processor.

7. Gift Certificates

Gift Certificates are another tender type supported by the POS system 108 of the present invention. Support for gift certificates includes the following:

The ability to prompt for entry of the alpha/numeric gift certificate number and the amount. The gift certificate must pass check digit validation.

The ability to accept multiple gift certificate medias.

The ability to validate the gift certificate number and amount against a negative (previously redeemed) gift certificate file. If the gift certificate number is not on file, it is accepted as a viable tender.

The ability to print a redemption endorsement (definable by the retail store) on the back of the gift certificate.

The ability to set “cash back” limits for the gift certificate. If the “Change Due Customer” exceeds the cash back limit, a gift certificate credit slip is issued.

The ability for all data captured regarding gift certificates tendered to be logged and available for transmission to host as well as available for inclusion in In-Store reports.

The ability to print and accept bar-coded gift certificates.

The ability to capture and track information for multiple types of gift certificates.

The ability to maintain a negative gift certificate file.

8. Foreign Currency

The POS system 108 also preferably supports foreign currency conversion. Foreign currency tender capability includes the following: The ability to display the transaction total in both foreign currency and US currency.

The ability for the cashier to enter the amount paid in foreign currency. The POS system 108 automatically converts the foreign currency entered into US currency and calculates and displays the amount of change due in US currency.

The ability to change conversion rates from the Host or at store level.

9. Express Shopper Points

Express Shopper points, described below, may also be used as a valid tender type in the preferred embodiment.

Referring to FIG. 4, the shopper savings program 120, implemented at the front end POS system 108, is a key component of the business method of the present invention. It is comprised of three basic areas of functionality:

i. Customer Demographics Capture/Tracking 170;

ii. Express Savings Programs (special promotions/deals available to Express Customers) 172; and

iii. Express Customer Points Program 174.

Customer Demographic Capture

Customer demographics capture 170 provides the ability to analyze customer purchase data to ascertain customer buying patterns by location, emerging market trends, market basket analysis, and promotional measuring. Customer Demographics capture 120 is implemented using an Express Customer Card to identify the preferred or Express customer. When a customer requests an Express customer card, an Express customer file is established at the host computer. A Customer number, typically a standard NSC 4 UPC number is assigned by the ISP. Customer information is input via a remote host terminal 112, and files are updated thereafter through the POS system 108, customer display 124 or other peripheral device.

In addition to demographics/transaction history capture the Customer Card can be used as a check cashing card. When a check is identified at tender time, the system has the ability to scan the Customer card in lieu of entering the check number or identification unless the card was previously entered prior to accepting the check. The system then initiates a check authorization request from Host 112.

When the Express Customer Card is presented at the point-of-sale it is scanned (or the number key entered if unable to scan) and the Customer record is retrieved from the Host 112. The POS terminal 124 prompts for the Customer Card to be scanned/entered as the first step in a new transaction, with bypass capability if the customer is not an Express member. In the preferred embodiment, the Customer Card may be scanned/entered at any point in the transaction. Once the number is entered and accepted, the customer is then entitled to take advantage of the Express Savings 172 and Express Points 174 programs. As will be more fully described below, the Express Savings 172 and Express Points 174 programs include the ability to earn and redeem Express Points, earn/redeem manufacturer electronic coupons, request/redeem an Electronic Rainchecks and qualify for Express Customer Discount Prices/Special Promotions. In the preferred embodiment, electronic discounts are given as soon as the card number is accepted. Host 112 response is not required before discounts are applied. The order may be processed whether or not response is received from Host 112. When the transaction is finalized, the transaction data pertaining to the Express transaction is sent to Host for master file update (store and forward facility).

In the event that the customer's Express Number as scanned/entered cannot be found at Host or the customer does not have possession of their card/number, the system prompts for input of an alternate ID. Alternate ID look-up consists of any personal information stored in the customers record at Host (i.e., drivers license, customer name/address, social security number, etc.). Alpha/numeric input capability at the POS terminal 124 is required for this function.

If the Host 112 cannot find the Express Customer's record, a “Not on File” message is returned to the store to alert the cashier that the Express number cannot be found. The cashier has the option of entering the alternate look-up number at that point.

If the customer record cannot be found using an alternate look-up method and the customer has presented an Express Savings Card, the system allows the transaction to proceed as an Express transaction, using the number on the card. Supervisor override may be required.

If the customer does not present an Express Customer Card and a number cannot be located by alternate look-up means, the system handles the transaction as a “non-Express Member” transaction. Even without a Customer Card or number, however, supervisor override capability allows the system handle the transaction as an Express customer as deemed appropriate.

Express Savings Programs

Referring still to FIG. 4, the express savings program 172 provides the ability to offer rewards (e.g. coupons, gift certificates, etc.) and multiple pricing structures to individual customers based on purchase levels and shopping habits, and may be implemented using multiple devices including POS terminals 124, kiosks and the internet. The Express Savings Program 172 is preferably adapted for use in all store departments including, for example, the Bakery, Floral, Seafood, Sandwich and Deli departments of a large supermarket. In the preferred embodiment, the express savings program 172 is entirely “paperless” so that all activities including discounts, in store couponing, and raincheck generation, for example, are handled electronically. It is an important aspect of the present invention that the express savings program 172 has the flexibility to easily change program offerings and respond rapidly to shifting customer/market trends, and to create a fun and exciting shopping environment via special programs, such as a “500^{th} visit award”, “secret item of the week purchase, compensation for a store “goof” (applied at the point of sale), or rewarding a customer for assisting in an endeavor such as test marketing an item, or filling out a survey, or acknowledging a customer during special promotions by issuing a gift certificate or other type of award.

On an exception basis, the present invention also allows all customers to participate in the Express Savings Program 172 without having been previously enrolled. This feature is typically implemented for new store openings or to promote the Express Savings Program in particular areas. Under these circumstances the present invention provides the ability to determine what “Express Level” will be extended to all “non-Express” customers and the duration of this special promotion. An existing Express Customer shopping in the store during this type of promotion is entitled to the appropriate discounts and promotions afforded his/her specific Express level.

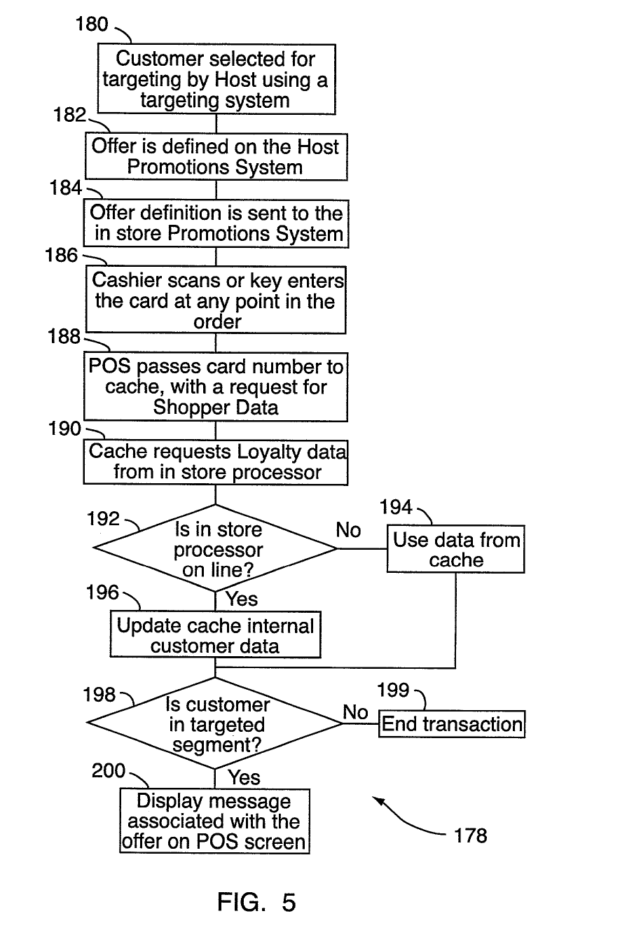

Referring to FIG. 5 in an embodiment of a ‘special event’ promotion 178 for an Express Customer, a customer is selected for targeting by the Host 180, and an offer is defined on the Host Promotions System 182 targeted at a reserved segment. The offer is then sent to the ISP promotions system 184 and becomes one of the promotions in the promotion file. Later in the store, when the cashier scans or key enters the Express Customer Card 186 the POS system 108 passes the card number to a cache with request for shopper data from the Customer file 188. The cache is the interface between the Point of Sale terminal 124 and the Customer Loyalty Program 118 (See FIG. 2). The Loyalty program 118 provides information to the cache, and the POS terminal 124 interrogates the cache for shopper information when required. The cache requests loyalty data from the Customer Loyalty Program 118 residing in the in-store processor 190 and waits for a response. If the ISP is not on-line 192 the POS uses customer data in the cache 194. When the response is received, the cache uses the response to update its internal customer data 196. If the customer is in the targeted segment 198 the POS screen 129 displays a message associated with the offer 200. At the end of the transaction, the POS terminal 124 passes a Customer Loyalty update message to the cache, indicating that an award has been given on that offer, and proceeds to the next transaction. If the customer is not within the targeted segment the transaction is ended 199 normally.

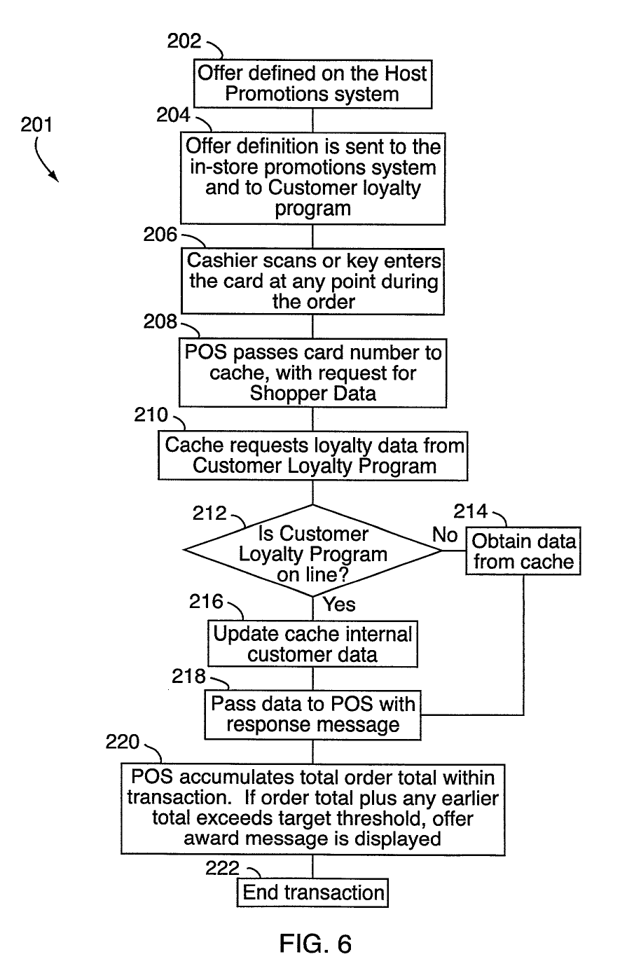

Referring to FIG. 6, the “turkey coin” is an offer that gives an award based on a threshold, typically a purchase amount threshold. For example a “free turkey coin” to everyone who spends $150 the month before Thanksgiving may be provided. Customers who earn these “free turkey” coins, preferably have to redeem them within a certain timeframe (e.g., two weeks).

In an embodiment of the “turkey coin” sequence 201 an offer is defined on the host promotions system, 202 defined as a single-threshold continuity offer. It is typically targeted at all customers. The offer definition is sent to the in-store promotions system and to the Customer Loyalty program 204. Later in the store the cashier scans or key enters the Express Customer card at any point during the order 206. The POS terminal 124 passes the card number to the cache, with a request for shopper data 208 and waits for a response and the cache requests loyalty data from the Customer Loyalty Program 210. If the Loyalty program is off-line 212 all data will be obtained from the cache 214. When a response is received, the cache uses the response to update its internal customer data 216. The data is then passed to the POS terminal in its response message 218 the POS accumulates total order total within the transaction. If the order total plus any earlier total exceeds the target threshold, it displays the offer's award message 220. At the end of the transaction 222, the POS terminal passes a Customer Loyalty normal update message to the cache, indicating the incremental order total in that transaction, and whether an award has been given on that offer, and proceeds to the next transaction. The cache uses the update message to update its internal totals and then inserts the Loyalty data into a store and forward queue from which it is transmitted to the Customer Loyalty program. The forwarding process waits for a positive response before deleting the message from the queue and forwarding the next update.

Other promotional programs may give awards based on multiple thresholds. One example is the use of multi-colored coins that are redeemable by frequent shopper customers based on cumulative spending over time. For example a red coin might be issued a $250 threshold; a silver coin at a $500 threshold; a blue coin at $750 threshold and a gold coin at a $1,000 threshold. Thresholds may vary by store. When a customer reaches a reward threshold (information provided in frequent shopper record from the host, the cashier rewards the customer with the appropriate coin. After the gold coin is earned, the threshold cycles back to the Red Coin. Any value spent above the $1,000 threshold is applied against the Red threshold.

Every month the store offers selected in-store products for coin redemption (e.g. two product choices per coin level) and customers elect to redeem their coins for these free products at the POS. Encoded in the POS system are the PLUs for the selected products which are treated as coded store coupons, or negative PLUs. When the customer redeems a coin for a free product, the cashier collects the coin and rings up the appropriate negative PLU.

In the preferred embodiment, and based on a selected parameter applicable to all coin thresholds, the ISP may establish a dollar value above/below the threshold where the store may elect not to issue the coin until the next customer's next visit.

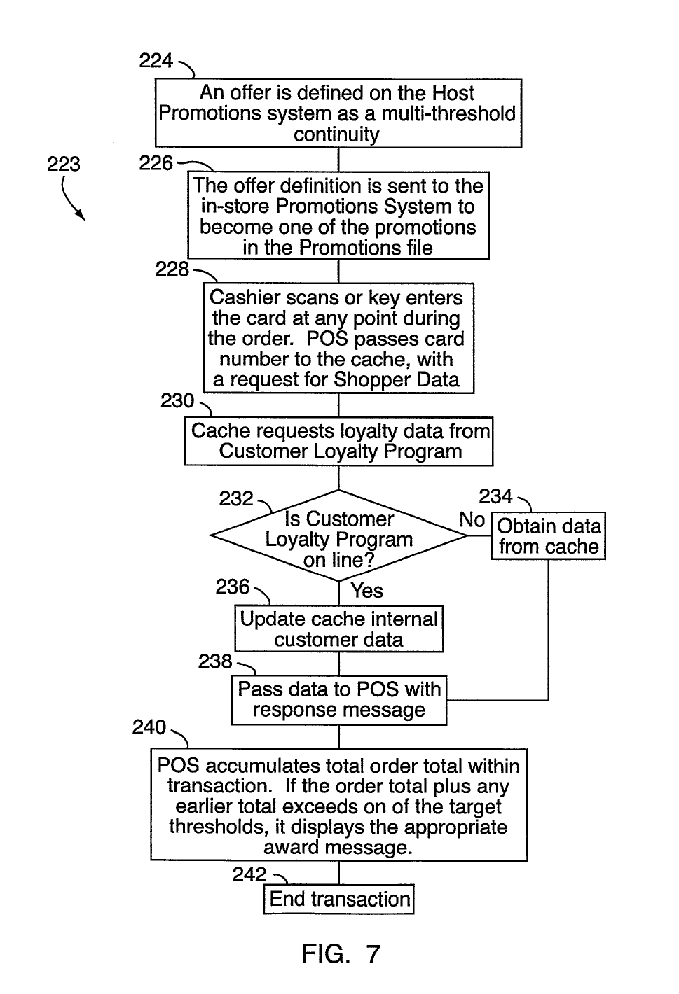

Referring to FIG. 7, the sequence of events for the multi-colored coin awards 223 starts with an offer defined on the Host promotions system as a multi-threshold continuity award 224. The offer can be targeted at one or more segments. The offer definition is sent to the in-store promotions system 226 and becomes one of the promotions in the promotions file. Later in the store, the cashier scans or key enters the Customer card at any point during the order. The POS terminal passes the card number to the cache with a request for shopper data 228. The cache requests loyalty data from the Loyalty program 230 and waits for a response. If the Loyalty program is off line 232 all data will be obtained from the cache 234. When the response is received the cache uses the response to update its internal customer data 236. The data is passed to the POS in its response message 238. The POS terminal accumulates total order total within that transaction. If the order total plus any earlier total exceeds one of the target thresholds, it displays the appropriate award message 240. At the end of the transaction 242, the POS terminal passes a Customer Loyalty normal update message to the cache, indicating that the incremental order total in that transaction, and the amount awarded on that offer, and proceeds to the next transaction. The cache uses the update message to update its internal totals. The cache also inserts the Customer Loyalty data into a store and forward queue from which it is transmitted to the Customer Loyalty program database. The forwarding process waits for a positive response before deleting the message from the queue and forwarding the next update. In the preferred embodiment, the thresholds are store-specific. In store file maintenance is preferably provided to allow thresholds to redefined at the store level.

The business method of the present invention also supports multi-tiered programs for different levels of Express Customers. For example, depending on definable and flexible criteria, a customer may be designated as Gold, Silver, or Bronze where Gold customers receive 15% all or select items, Silver Customers receive 10% off; Bronze customers receive 5% off all or select items.

More elaborate multi-tiered promotional schemes are also supported. For example: Gold customers qualify for their standard percent off plus are allowed to participate in a triple coupon promotion and qualify to participate in a special promotion of 25% off all Brand X canned vegetables between 1:00 p.m. and 2:00 p.m. every Tuesday while accumulating double points on select items purchased; Silver Customers qualify for their standard percent off select items plus are allowed to participate in the 25% off all Brand X canned vegetables between 1:00 p.m. and 2:00 p.m. every Tuesday and receive double coupons on select items if this is the first Tuesday of the month; Bronze customers qualify for their standard percent off of select items and receive triple Express Savings points all week (because this is Bronze Customer appreciation week) but not qualify for the 25% Brand X promotion or triple/double coupon promotions on select items.

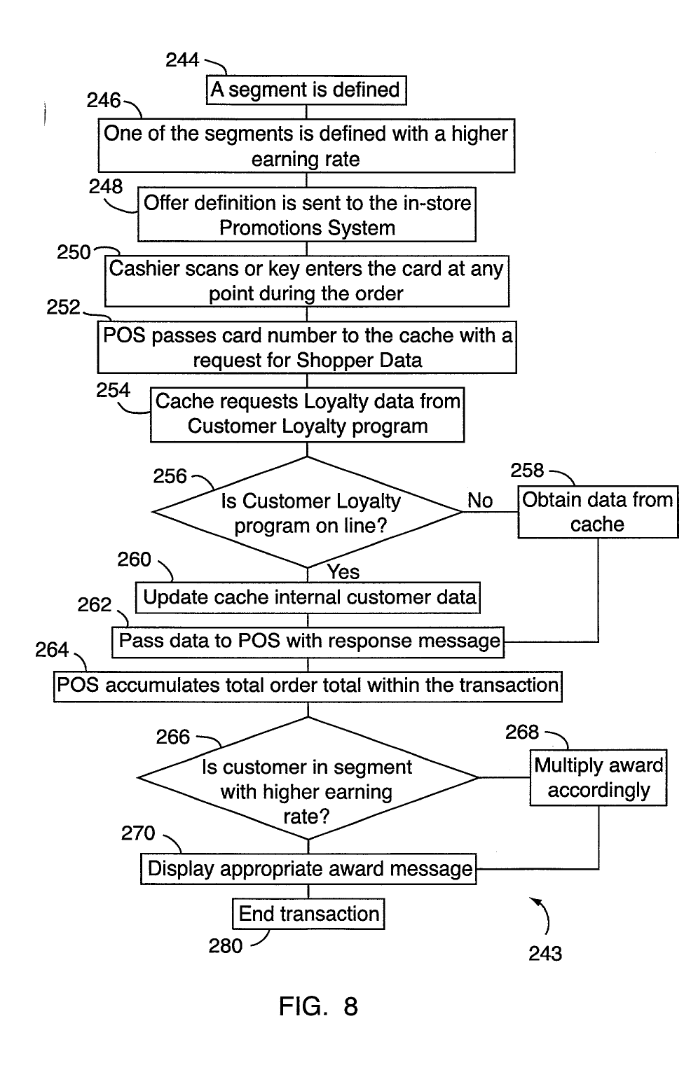

Referring to FIG. 8, the multi-colored coins promotion program 243 can be enhanced with accelerated earnings for shoppers in particular segments. (e.g., gold, silver and bronze). These promotional offers give awards based on multiple thresholds, allowing accelerated earning of coins for a shopper in a particular segment. First, a segment is defined 244 by the Host 112. For example, a segment could be defined to include all customers whose address is in a particular zip code and who shop in a particular store. One of the segments can be defined with a higher earning rate 246. The offer definition is sent to the in-store Promotions System 248. Later in the store, the cashier scans or key enters the Customer Card at any point during the order 250. The POS passes the card number to the cache with a request for shopper data 252. The cache requests loyalty data from the Customer Loyalty program 254 and waits for a response. If the Customer Loyalty data is off line 256, all data is obtained from the cache 258. When the response is received, (Customer Loyalty program on line) the cache uses the response to update its internal customer data 260. The data is passed to the POS in its response message 262. The POS accumulates total order total within that transaction 264. If the customer is in the segment with a higher earning rate 266 the order total is multiplied accordingly 268. If the order total plus any earlier total exceeds one of the target thresholds, the POS displays the appropriate award message 270. At the end of the transaction 280, the POS passes a Customer Loyalty normal update message to the cache indicating that the incremental order total in that transaction and the amount awarded on that offer, and proceeds to the next transaction. The cache uses the update message to update its internal totals and inserts the Customer loyalty data into a store and forward queue from which it is transmitted to the Customer Loyalty program in the ISP. The forwarding process waits for a positive response before deleting the message from the queue and forwarding the next update. Since, by definition, the thresholds are store-specific, in-store file maintenance will be provided to allow thresholds to be redefined at the store level.

Another promotional program, the “Express Millions” program involves the use of a “Platinum Coin”. This reward gives a targeted award to one customer in a list. The reward is typically given only once, across all customers and across the entire store chain. In this program Winning Express card numbers are transmitted to stores and loaded into a file. At the end of the transaction, the system checks to see if the Express card number entered is a winning number. Additionally, random winners are selected based on transaction number. One in every “X” transactions, as determined by store headquarters, is be selected as a random winner. At the end of every transaction, the POS terminal's millisecond timestamp is used to check and see if the transaction is a random winner. In either case, when a winner is detected by the system, the POS terminal may sound off (siren, cheering/clapping hands, etc.) and flash “RANDOM WINNER” or “EXPRESS WINNER” on the customer display as well as print a winning message on the receipt.

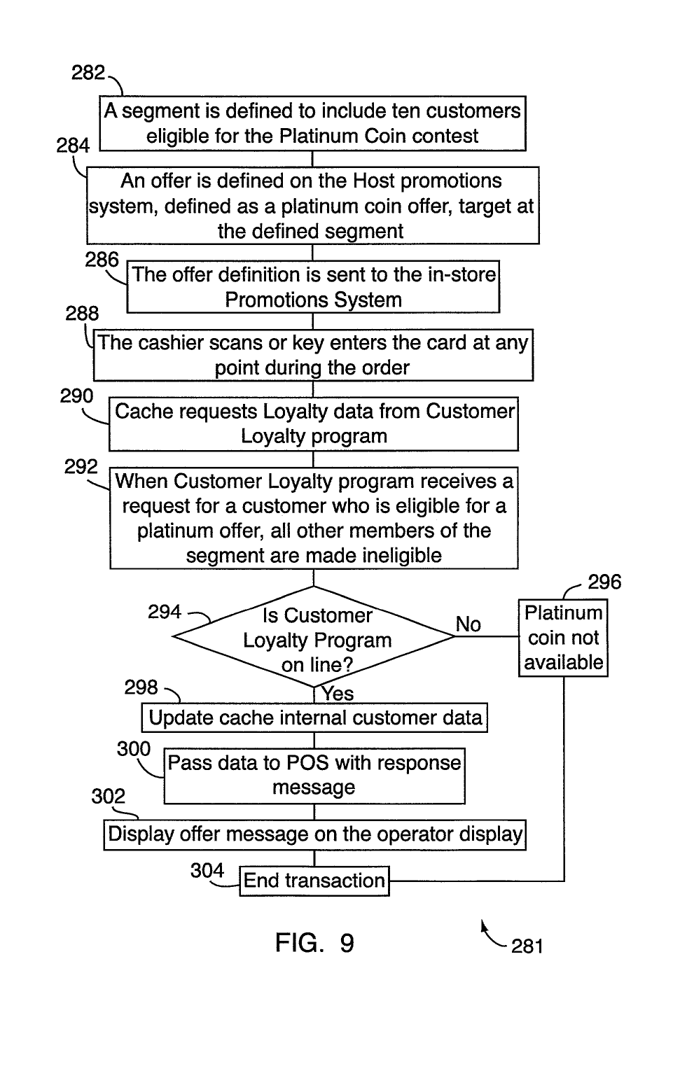

Referring to FIG. 9, the first step in the Express Millions promotion sequence 281 is for a segment to be defined by the Host to include ten customers eligible for the Platinum Coin contest 282. An offer is defined on the Host promotions system, defined as a platinum coin offer. The offer is targeted at the defined segment 284 and sent to the in-store promotions system 286. Later in the store, the cashier scans or key enters the Customer Card at any point during the order 288. The POS passes the card number to the cache with a request for shopper data. The cache requests loyalty data from the Loyalty Program 290. When the Loyalty Program receives a request for a customer who is eligible for a platinum offer, all other members of the segment are made ineligible 292. If the Customer Loyalty program is off line 294 the platinum coins are not available 296. If the Customer Loyalty program is on line, and a response received, the cache uses the response to update its internal customer data 298. The data is then passes to the POS in its response message 300. If the POS detects that the customer is in the reserved segment, it displays the offer message on the operator display 302. At the end of the transaction 304, the POS passes a Customer Loyalty normal update message to the cache, indicating that the award has been given in that transaction. The cache uses the update message to update its internal totals. The cache then inserts the Customer Loyalty data into a store and forward queue from which it is transmitted to the Customer Loyalty program. The forwarding process waits for a positive response before deleting the message from the queue and forwarding the next update. The POS then triggers an external alarm device to indicate that someone has won the Express Millions award (i.e. the platinum coin).

As will be understood by those skilled in the art, the foregoing is but one of a variety of customer “customer-focused” games and promotions that may be utilized by the business method of the present invention.

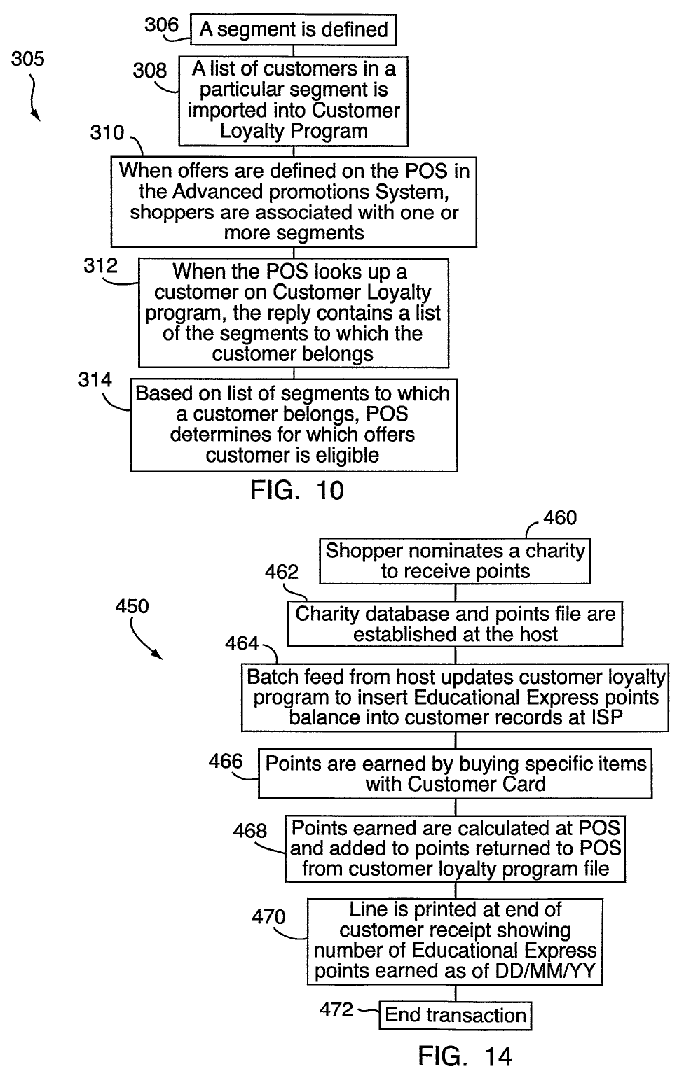

Referring to FIG. 10, the method of targeting customers by segment 305 is outlined. First a segment is defined 306. A list of customers in a particular segment is then imported into the Customer Loyalty program residing on the ISP 308. When offers are defined on the POS in the promotions system, shoppers are associated with one or more segments 310. When the POS looks up a customer on the Customer Loyalty Program, the reply contains a list of the segments to which the customer belongs 312. The POS 108 then uses these segment numbers to determine for which offers the customer is eligible 314.

The Express Savings Program 172 (See FIG. 4) preferably supports a wide variety of promotional types. Other types of Deals and Promotions supported by the express savings program 172 include the following:

1. Traditional Deal e.g., “30% Off Brand X Aspirin”

2. Every Day Deals e.g., “Buy 1-Get 1 Item free” (These are deals that run on a daily basis.)

3. Buy X of a Specific Item and Save $ e.g., “Buy 12 Jars Brand X Baby Food Save $1.00”. If the quantity purchased is less than the specified number, the customer pays the “per jar price with no discount.

4. Pay X Price When You Buy Y Lb. or More e.g., “Store Baked Ham—$2.98/lb When You Buy 1 LB or More”. Any weight less than the minimum amount specified would not be discounted.

5. Random Weight Buy 1 and Get 1 Free e.g. “Buy 1 Pkg. Brand X Chicken Breast-Get 1 Free”. These discounts are typically set up so that the one of equal or lessor value is the one that is given free.

6. Buy X or More and Save X Cents Each, e.g., “Brand X Canned Vegetables—Buy 4 or More, Save 5 Cents Each”; “Buy 6 or More, Save 8 Cents Each”; “Buy 10 or More, Save 0.10 Cents Each”.

7. Buy X or More and Save Y % Each e.g., “Buy4 or More, Save 3% Each”; “Buy 6 or More, Save 5% Each”; “Buy 10 or More, Save 7% Each”.

8. Spend X and Save $ On An Item(s) e.g., “Spend $20.00, Save $1.00 on Brand X diapers”; “Spend $50.00, Save $2.00 on Brand X diapers”.

9. Spend X and Save % On An Item(s)-“Spend $35.00, Save 5% on Brand X diapers”; “Spend $75.00, Save 10% on Brand X diapers”.

10. Buy One Item and Get A Different Item Free, e.g., “Buy Hot Dogs, Get Rolls Free”; Buy Cheese and Ham, Get Mustard Free”.

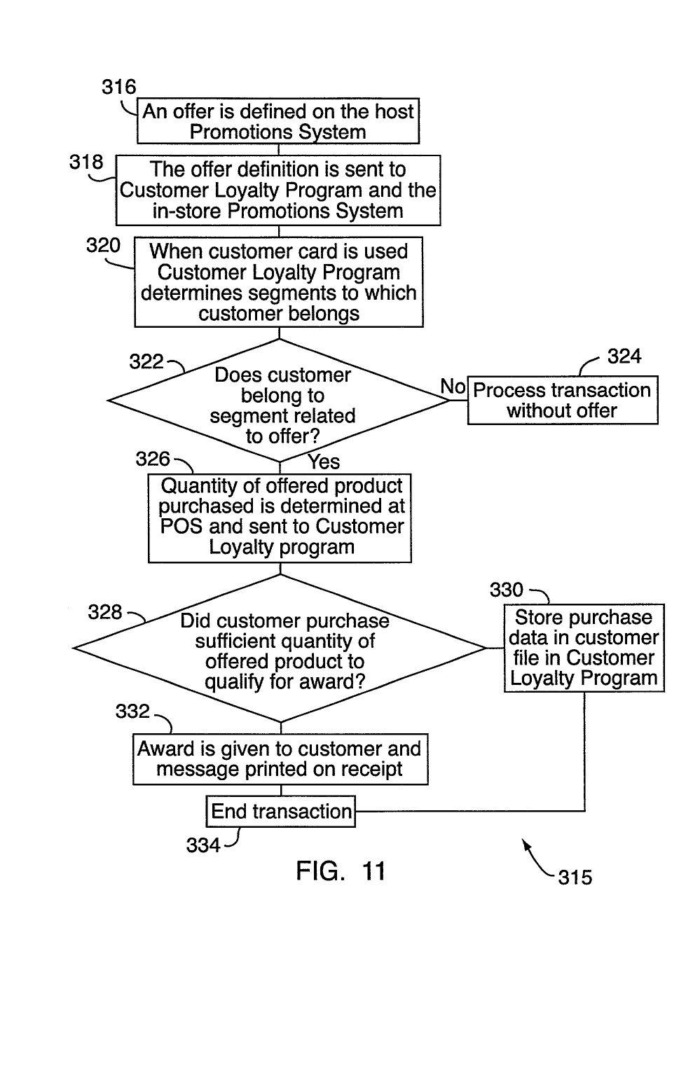

Referring to FIG. 11, all offers having a buying requirement typically have the option of defining it such that the buying requirement is outside a single transaction. Such a ‘continuity’ offer is typically one of the following types:

Buy X of a specific item, get Y items free.

Buy X of a specific item and save $.

Buy X of a specific item, get another item free.

Buy X lbs. of an item, get Y.

Buy X of a specific (random-weight) item, get Y.

Buy X or more, save Y cents each.

Buy X or more, save Y % each.

In all of the above cases, dates of the promotion are set by the retail store (from Date X to date Y) such that X is the continuity total for each offer type measured over the time of the promotion.

Referring still to FIG. 11, in a typical embodiment of a continuity offer sequence 315 an offer is first defined on the Host Promotions System 316. The definition indicates that the offer is one of the above types, includes the value of X and defines the segments to which it applies. The offer definition is sent to the Customer Loyalty Program and the In store promotions program 318. When a customer card is used, the Customer Loyalty response includes segment numbers to which the customer belongs 320. If the customer belongs to the segment related to the offer, 322, the POS system recognizes that fact and begins to accumulate X. At the end of the transaction, an offer sub-entry is sent to the Customer Loyalty program, with a total indicating the number of times the award has already been given, and the customer's accumulated X so far 326. If the customer does not belong to the targeted segment, the transaction is processed without the offer 324. When the card is next used, the offer sub-entry is returned by the Customer Loyalty program, with a total indicating the number of times the award has already been given, and the customer's accumulated X so far. If the POS system detects that the customer's order total in that transaction has crossed the threshold, 328 it triggers the award and notes this fact in the offer sub-record sent back to the Customer Loyalty program 330. When the award is triggered 332 messages will be printed on the receipt. At the end of the transaction 334 messages will be printed, indicating progress against continuity offers. At a later time, when the offer has run its course, the offer and associated totals are cleared from the system.

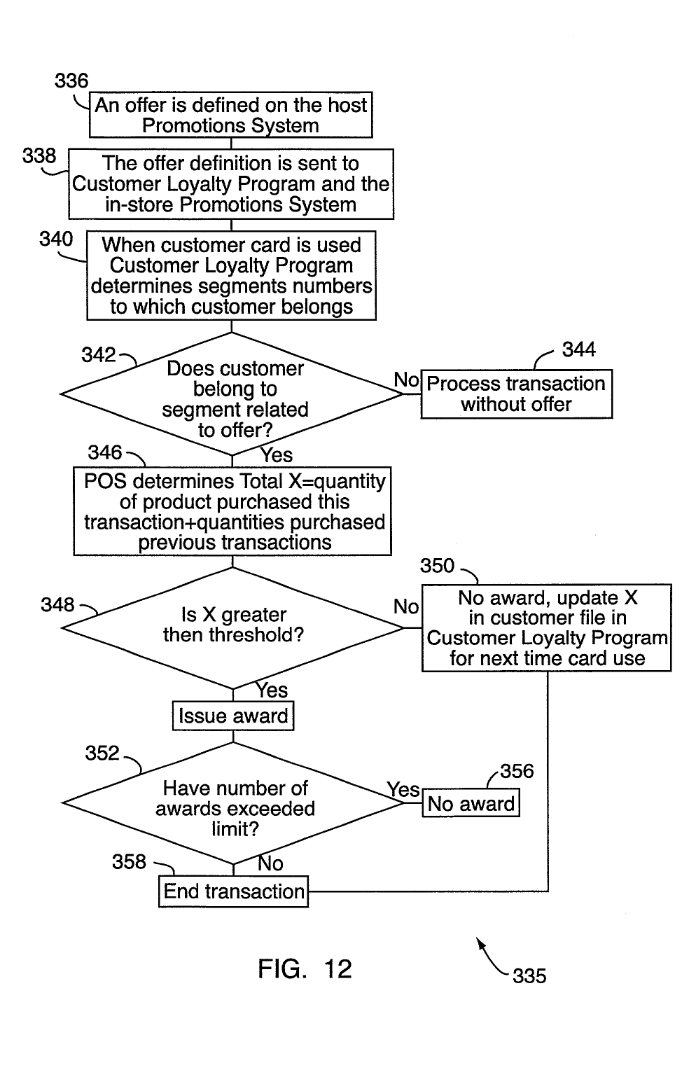

Referring to FIG. 12, limited continuity offers may also be made according to the steps 335 shown. Limited continuity offers are used typically for only a very small number of very valuable offers (e.g. twenty at a time). They can also limit some offers to a one-time-only reward. As shown in FIG. 12, an offer is first defined on the Host Promotions System 336. The definition includes the offer type, any continuity thresholds, the limit, and defines the segments to which it applies. The offer definition is sent to the Customer Loyalty program and the in-store promotions system 338. When a customer card is used, the Customer Loyalty program response includes segment numbers to which the customer belongs 340. If the customer belongs to the segment related to the offer 342 the POS system recognizes the fact and begins to accumulate awards towards the threshold 346. If X is greater than the threshold 348, an award is issued 352. If not an award is not given the Customer Loyalty program is updated for next time card use 350. If the customer does not belong to the targeted segment the transaction is processed without the offer 344. At the end of the transaction, an offer sub-entry is sent to the Customer Loyalty program including the increase in X in that transaction, and whether or not the award has been given 348. When the card is next used, the offer sub-entry is returned by the customer loyalty program, with a total indicating how often the award has already been given, and the customer's accumulated X so far. If the POS system detects that the offer has exceeded its limit 354 it ignores it 356 and ends the transaction normally 358.

All weekly promotions or specials are electronically applied at the point of sale. Although there are many options available, there are certain characteristics that are the same for all deals: Any deal can be set up for any specified time period (minutes, hours, days, weeks, etc.). Only one time period is typically allowed per deal but up to 7 days can be specified individually. For example: Monday, Wednesday and Friday between 2:00 p.m. and 3:00 p.m. The deal can be set to have a Minimum Total Purchase requirement of any dollar amount. The ability to flag specific items/departments (such as cigarettes and alcohol) as not allowable in the Minimum Total Purchase amount is also common to all deals. The deal can be limited to a quantity of 5 or any other number per customer per visit and/or per period as defined by the store. For example, a customer may be limited to purchasing an item quantity of “X” per visit. OR, the deal may be structured to allow an Express Customer to purchase a total quantity of “X” for the entire duration of the promotion. The deal can also have Express Points 174 associated with it, depending on the items purchased or any “points related” promotions that may be in effect. See description of Express Points Program 174, below.

Express Customer coupons, available only to those customers with a customer card, are the core of express savings program 172. With Express Customer coupons discounts are given electronically; the customer is not required to present a store-issued paper coupons. Once a Customer Card number is scanned/entered, the transaction is identified as an Express customer transaction and all discounts are automatically applied to the order. If the card is scanned/entered in the middle of the order, the system checks a “coupon bank” for this transaction to see if any Express items have already been entered. If previously entered Express Items are found, the system automatically prints the discounts for these items. If there are not any coupons in the “coupon bank”, the order continues as normal with the discounts showing directly under the item that is scanned.

In the preferred embodiment, all coupons except rain checks (see below), are issued electronically to all customers who purchase the associated item(s) and meet all other requirements stipulated by the published description of the coupons in store circulars, for example. The requirements (triggers, minimum purchase amounts, pools, marketing programs IDS, etc.) are embedded in the item PLU and coupon PLU records along with the code that interprets them. The coupons, when earned, are deposited into a coupon bank that exists for the duration of the transaction. Redemption of the coupons may be immediate or delayed depending on the coupon type and status of the transaction. In all cases, a coupon can only be redeemed once, even if the multiple methods of redemption exist, e.g., coupon PLU #, coupon bar code #, etc.

The parameters that define the coupon acceptance within a transaction are preferably easily changeable as well as user definable. Definable parameters include:

1. A limit on the number of coupons to be multiplied per transaction.

2. A limit on the maximum face value of the coupon amount to be multiplied.

3. A limit on the maximum total value of the multiplied coupon. This limits the total amount that can be subtracted from the transaction regardless of the coupon being doubled, tripled, etc.

4. A limit on the number of coupons that can be applied to a single item.

5. The ability to stop a coupon from exceeding the value of the item, regardless of whether the coupon is single, double, triple, etc.

6. A limit on any coupon that has a value greater than the total of the item.

7. If the customer has more than the allowed number of coupons, the highest coupon amount is automatically selected and applied to the order.

8. A limit on the number of shopping trips in which coupons can be used.

All coupons take on the Itemizer characteristics of the PLU item for which they are valid. The ability for multiple coupon amounts to use Itemizers different than the original PLU item for which it is intended is preferably provided, including food stamp itemizers and tax itemizers.

The ability to track and report coupon savings totals is also provided, with multiple amounts for coupons that are doubled or tripled reported as a separate total from the manufacturer coupon “face amount” total. When calculating double or triple coupon amounts and tax status, the multiplied amount of the coupon may not always use the same itemizer as the original amount of the coupon.

Several coupon types are preferably provided by the business method of the present invention.

I. Electronic Coupons

These coupons are preferably offered to all customers regardless of whether or not they have presented an Express Savings card. The discounts are applied directly after the featured item has been scanned/entered. There are no paper coupons that the customer must present to receive the discount. The Electronic Coupon cannot be entered into the system using a look-up key.

II. Express Customer Coupons

Express Customer Coupons are the core of Express Savings Program 172. Discounts are given electronically and there are no paper coupons (store issued) that the customer is required to present. Once an Express Card number is scanned/entered, the transaction is identified as a Preferred Customer transaction and all discounts are automatically applied to the order. If the card is scanned/entered in the middle of the order, the system checks a “coupon bank” for this transaction to see if any Express items have already been entered. If previously entered Express Items are found, the system automatically prints the discounts for these items. If there are not any coupons in the “coupon bank”, the order continues as normal with the discounts showing directly under the item that is scanned.

III. Clipless Coupons

Clipless coupons are offered to all customers regardless of whether or not they have presented an Express Savings card. The coupons are applied directly after the featured item has been scanned/entered. The POS system checks to verify that another type of coupon has not already been applied to the item before applying the clipless coupon discount to the order.

IV. Traditional Coupons

Traditional paper coupons are offered to all customers whether or not they have presented an Express Savings Card. A traditional paper coupon is presented to the cashier and the system checks the order to ensure that the item has been purchased. If the item has been purchased, the coupon is redeemed providing all requirements for the promotion have been met. These discounts are not electronic and are not automatically applied to the order.

V. Manufacturer Coupons

Manufacturer coupons may be scanned, key entered, or key entered as an amount into a department with multiple values (i.e., single, double, etc.). Coupons that cannot be scanned are key entered, using the same process as the manual entry of a PLU/UPC number. Coupons not containing a barcode are manually entered using the fixed or non-fixed department entry process. Validation of manufacturer coupons are based on the NSC-5 Coupon Code Guidelines. The coupon is validated against the items in the transaction based on a combination of the manufacturer code and the family code or on the manufacturer code only. Validation may be against the first digit of the family code or the first and second digit of the family code NSC-0 coupons follow the same validation guidelines. All value codes currently assigned by the Uniform Code Council are handled and allow for expansion of future value code assignments. Promotional validations such as “X for X” or “buy X-get X free” are also handled by the business method of the present invention.

In the preferred embodiment, coupons that are manually key entered are also able to be key entered into the specific department and may prompt the cashier for entry of the coupon item description. The optional ability for the system to automatically multiply coupons that are key entered is required. For Manufacturer Coupons multiple family codes may be associated with a single PLU for validation purposes. If the first family code does not match, each successive family code will then be used for validation. A coupon that has failed validation may be accepted with supervisor override. Information on those coupons that were rejected and coupons that were overridden is preferably collected and reported. In the preferred embodiment, totals of manufacturer coupons are available by merchandise department e.g., grocery, frozen food, etc and manufacturer coupon tax handling is preferably customizable by the retail store to meet all coupon tax handling requirements. The POS system of the present invention also preferably has the ability to electronically transmit coupon information directly to coupon clearing house(s).

It can be seen that the business method of the present invention significantly limits or eliminates the overhead required for traditional store coupon validation and handling while still allowing manufacturer coupons to be handled conventionally.

As noted above, total coupon savings per sales transaction is preferably printed on the customer receipt with customizable message and location of the message on the receipt. The savings totals are preferably calculated on separate Itemizers to allow for individual items, departments, and discounts to be added into the total.

VI. Multiple coupons

The POS system of the present invention also preferably includes the ability to automatically double, triple, or quadruple coupons at the time of entry. A pre-set limit on the number of coupons to be multiplied per transaction and the number of times a coupon can be multiplied (e.g., doubled, tripled, quadrupled, etc.) is provided as well as the ability to set parameters for Express customers and non-Express customers separately. In the preferred embodiment there are no “hard coded” limits pre-set in the POS system.

By way of example, if a customer's total order is between $25 and $50, they earn the right to triple “X” number of manufacturer coupons, up to but not exceeding the price of the item, for the duration of the triple coupon promotion. The customer may redeem their triple coupons during that order or have their triple coupon awards reserved for a future order.

In one embodiment, the POS system includes the ability to award triple coupons based on the on the number of visits to the store during a specified time period, (e.g., from-to; MM.-DD:YY.-YY1HHVM), total visits to the store since becoming an Express member, or Express member annual anniversary, for example. Preferably, all express Customer Levels qualify for a special Triple Coupon promotion based on total dollars spent in an order, e.g., each customer earns 5 triple coupons (up to X cents off) for every X dollars spent in an order.

The number of triple coupons earned/redeemed is stored in the customer file at host. When the customer's Express Savings card is scanned/entered and the customer record retrieved from host, the POS system preferably has the ability to display or print the number of triple coupons available to the customer (previously earned). At the end of the transaction the POS system displays the number of triple coupons earned in the transaction. The POS system also has the ability to print the number of triple coupons earned in this transaction, earned to date, redeemed in this transaction and redeemed to date. The number of triple coupons earned/redeemed for the transaction are stored and forwarded to host as a component of the customer file update at the end of the transaction. Preferably the POS system provides for limiting the number of triple coupons that can be earned, by visit or within a specified time period, with supervisor override capability.

If an item is participating in multiple promotions within the same time period, the POS system preferably has the ability to select the best deal for the customer. However, in the preferred embodiment of the business method of the present invention an item may only be discounted according to the structure of the deal for which the savings are given. The ability to allow manufacturer coupons within a deal are preferably determined by the retail store by line item, department or deal (promotional event).

In the event the store is off-line to the Host during a triple coupon or points promotion (see below), the POS system of the present invention preferably supports the ability to invoke an “honor” system for redeeming coupons, with supervisor override capability. While the system is in off-line operations, customer receipts are limited to printing the triple coupons or points earned, redeemed and total savings for this transaction only. When the system returns to an on-line status with Host, the ISP automatically resumes normal updates to Host and forwards any transaction updates posted while communications were down.

Rainchecks

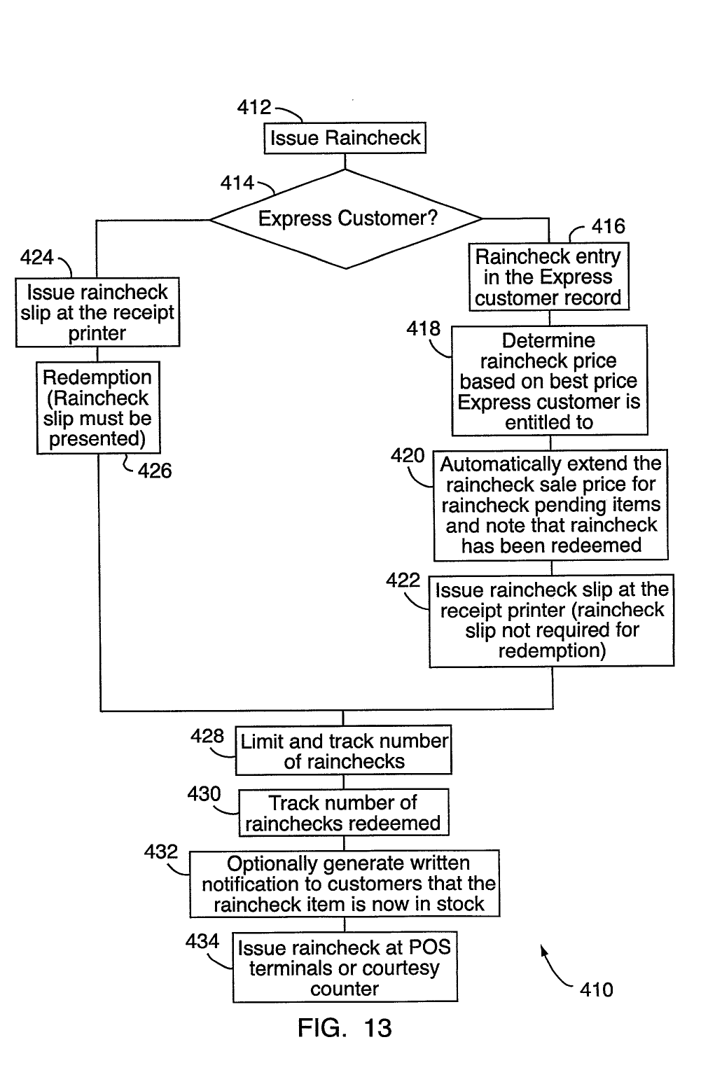

Referring to FIG. 13, a flow diagram of a raincheck in accordance with the present invention is shown generally at 410. In this embodiment, raincheck system 310 is part of the preferred shopper program of the POS system 108 and includes the ability to issue, track and redeem rainchecks electronically.

In block 412 of the flow diagram 410, raincheck is issued. If a raincheck is issued the system must determined if it issued for a preferred shopper or not in 414. For a preferred shopper program member (i.e., an express customer), the raincheck system 410 creates a raincheck entry 416 in the Express Customer record. The price of the raincheck item 416 will be determined by the best price that the Express customer is entitled to as illustrated in step 318. Stepping next to block 320, when the Express Customer purchases an item for which a raincheck is pending, the system will automatically extend the raincheck sale price and note that the raincheck has been redeemed. Once redeemed a raincheck slip may be issued at the receipt printer 422, however the raincheck slip is not required for redemption. Alternatively, the raincheck may by printed on the receipt itself during the time the customer is being rung up.

If in step 414 it is determined that the raincheck is issued for a non-Express Customer, then a raincheck slip is issued at the receipt printer in step 424, or the raincheck may be printed as part of the receipt itself. Thereafter, as illustrated in step 426, the physical raincheck slip must be presented for redemption of the raincheck.

Stepping to block 428, for both methods (express customer and non-express customer) of raincheck issuance and redemption the system includes the ability to limit the number of items covered by the raincheck, as well as the ability to track and report the number of rainchecks issued by item, date, time of day and cashier/operator as well as item regular price and item sale price. In block 430, the system also supports tracking the number of rainchecks redeemed to date (for all rainchecks). Additionally, the ability to set a HALO, with supervisor override, for the number of rainchecks redeemable by transaction or by cashier for a specified period may also be supported.

Optionally, the raincheck system 410 may automatically generate a written notification to customers that the raincheck item is now in stock, as illustrated in block 432. This would require the ability to capture or retrieve (if Express Customer) a name and address at the point of sale. When the out of stock items are replenished, the system would need to alert store personnel that notification cards should be printed.

Customer rainchecks are normally issued at the courtesy counter in a retail store. However, as illustrated in step 434 issuing rainchecks in-lane at a POS terminal 124 is also possible in this raincheck system 410. The raincheck system 410 preferrably supports the ability to issue, track and redeem rainchecks electronically by Express Shopper.

Express Points

Referring again to FIG. 4, the Express Customer Points Program 174 is the third basic area of functionality of the Shopper Savings Programs 120. The Express Points program 174 offers customers the ability to accumulate “Express Points” by purchasing select items. Accumulated points are redeemed at the point of sale and used to reduce the amount due on a customer's order or redeemed for larger prizes at the Customer Courtesy Desk.

Express Points are accumulated by purchasing specific items run during weekly specials. In addition to points per item, the store may run promotions in which points are awarded for specific items purchased during specified time intervals.

As with the Express Savings Program 172, the Express Points Program 174 also offers a variety of promotional programs including, but not limited to:

Multi-level linked promotions. In the preferred embodiment a minimum of eight levels per promotion are supported. This promotional tactic is used to group items for specific promotions (i.e., items required for a Thanksgiving dinner—Buy a turkey, stuffing mix, cranberry sauce, dinner rolls, and an apple pie and get $4.49 off.)

Department level promotions. A minimum of four department promotions with a minimum of four break points per department is preferably supported, where a break point is a dollar amount that must be equaled or exceeded to obtain points. Each break point provides a specific value that must be met. For example, Break Point 1=$25 earns 25 points, Break Point 2=$50 earns 50 points. etc.

If an item is participating in multiple promotions within the same time period, the business method of the present invention selects the best deal for the customer. An item is typically only discounted according to the structure of the deal for which the savings are given.

Express points are tracked by individual card holder and by household. Each member of a household can hold an individual customer card with points consolidated for the total household. A running total of Express Points earned and redeemed is maintained in the customer/household database at the Host computer 112.

In the preferred embodiment, points are calculated and displayed after the <TOTAL>key is pressed at the POS terminal 124. The business method of the present invention supports the ability to display both the points earned in this transaction and the total available points. The customer can then redeem Express Points for “cents off” of particular items, per weekly specials. Express points previously accumulated as well as points earned in this transaction can be redeemed.

Express Points are preferably redeemable for a specific item or group of items. In one embodiment of the present invention, a UPC number is assigned for each redemption promotion. The system validates that the item has been purchased. The cashier must enter this UPC number to record points being redeemed. The redemption UPC's will affect the total sales amount of the transaction and the redemption counter for the customer.

When the transaction is finalized, a recap of Previous Points earned, Points Earned This transaction, Points redeemed this transaction and points to date are printed on the customer receipt in addition to total savings this transaction. The Express points earned/redeemed for this transaction are then uploaded to the host computer.

Express points earned and express points redeemed are also updated in the store totals for end-of-day reconciliation. During the end-of-day processing, the ISP 110 will compare the total points earned for the day and the total points redeemed for the day. If the resulting number is not in balance, the Store administrator and the Host 112 are alerted.

When the customer card is scanned or the customer number key entered, a request is immediately sent to the Host for download of the household or customer points information record.

In addition to the aforementioned promotions, the Express Points program 174 of the present invention also preferably provides the ability to support community educational goals by allowing area schools to earn computer equipment, sporting goods, musical instruments, textbooks, teaching aids and the like. Express Points are assigned to specific items in the item file and as items with Express Points are purchased by customers, the points are logged, by UPC code and by customer, and forwarded to the host computer for updating in an Educational Points file maintained at host. The number of points by item and the total points earned are printed on the customer receipt. The POS system 108 is not typically involved in the redemption process of Education Points. Points Available statements are forwarded to participating schools from store headquarters on a regular basis. The schools may then redeem the points through store headquarters for specific articles as defined in the program. It will be understood that the same method may be applied to other important civic or charitable organizations as well as area schools.

Referring to FIG. 14, a typical sequence of events for the Educational Express program is shown generally at 450. These offers are typically not tracked electronically.

First, the shopper nominates a charity to receive points donated on his behalf 460, A charity database and points file are established at the host 462. A regular batch feed from the host updates the Customer loyalty program to insert Educational (or other charity) 464. Points are earned by buying specific items with the customer card 466. Points are calculated by the POS terminal 124 and added to points returned to the POS terminal 124 from the Customer loyalty file 468. A line is printed at the end of the customer receipt showing the number of Educational Express Points earned as of DD/MM/YY, 470 and the transaction ended. 472.

Error Conditions

In the preferred embodiment, the POS system 108 provides for several error conditions including the following:

In the event that a line item with associated Express Points is voided, the POS system 108 also voids the points earned.

In the event that a line item participating in a promotion is voided, the system should also void the discount(s) applied.

If a transaction, with points earned and/or redeemed or discounts is Post Voided, an update is sent to the Host for updating of the triple coupon, or Points Program database.

If the store system is operating off-line to the Host, points are redeemed on the “honor ” system, with supervisor override capability.

While the invention has been described with reference to a preferred embodiment, those skilled in the art will appreciate that certain substitutions, alterations and omissions made be made without departing from the spirit thereof. Accordingly the foregoing description is meant to be exemplary only, and not as a limitation on the scope of the invention set forth with the following claims.

What is claimed is:

1. A computerized system for a retail environment comprising:
a host computer;
an in store processor in electrical communication with the host computer; and
a Point Of Sale system including,
a primary point of sale server in electrical communication with the in store processor, and
a POS terminal, in electrical communication with the primary point of sale server, for use by a cashier to interact with a customer at a point of sale, the POS terminal including,
a central processing unit,
a cashier display for use by the cashier at the point of sale, and
a customer display for use by the customer at the point of sale,
wherein the cashier display and the customer display are directly controlled by the central processing unit such that they are interactive with each other.

2. The computerized system of claim 1 wherein the Point Of Sale system includes:
a secondary point of sale server in electrical communication with the primary point of sale server;
wherein the primary point of sale server has sufficient memory to include a plurality of relational databases which receive and store date from the Point Of Sale system, and wherein the primary and secondary point of sale servers are interactive such that the plurality of relational databases are updated on a substantially real time basis.

3. The computerized system of claim 2 wherein the primary point of sale server is in electrical communication with a plurality of POS terminals which input data to the relational databases from a plurality of points of sale of the Point Of Sale system.

4. The computerized system of claim 3 wherein the in store processor includes an inventory management system which is integrated with the relational databases of the primary point of sale server such that the inventory management system is updated on a substantially real time basis.

5. The computerized system of claim 4, wherein the host computer is in electrical communication with a plurality of in store processors, the host computer including sufficient memory for at least one relational database which is updated from the in store processors on a substantially real time basis.

6. The computerized system of claim 4 comprising:
a host LAN including,
the host computer,
a switch electrically connected to the host computer,
a plurality of main servers electrically connected to the host switch, and
a router electrically connected to the switch; and
an in store LAN electrically connected to the host LAN, the in store LAN including,
the in store processor,
the primary point of sale server,
the secondary point of sale server, and
the plurality of POS terminals;
wherein the host LAN and the in store LAN comprise a wide area network.

7. The computerized system of claim 4 comprising:
an electronic shelf labeling terminal in electrical communication with the in store processor; and
a hand held unit in wireless communication with the electronic shelf labeling terminal, the hand held units being designed to read bar codes of stock items.

8. The computerized system of claim 7 wherein the hand held unit is integrated with the inventory management system and the relational databases of the primary point of sale server to provide an output based on the bar code of each item read of at least one of:
a current price per item;
a quantity of items currently in stock; and
an amount of items sold per time of day.

9. The computerized system of claim 8 wherein the output of the hand held unit is updated on a substantially real time basis.

10. A computerized system for a retail environment comprising:
a host computer;
an in store processor in electrical communication with the host computer; and
a Point Of Sale system including,
a primary point of sale server in electrical communication with the in store processor,
a secondary point of sale server in electrical communication with the primary point of sale server, and
wherein the primary point of sale server has sufficient memory to include a plurality of relational databases which receive and store date from the Point Of Sale system, and wherein the primary and secondary point of sale servers are interactive such that the plurality of relational databases are updated on a substantially real time basis.

11. The computerized system of claim 10 wherein the primary point of sale server is in electrical communication with a plurality of POS terminals which input data to the relational databases from a plurality of points of sale of the Point Of Sale system.

12. The computerized system of claim 11 wherein the in store processor includes an inventory management system which is integrated with the relational databases of the primary point of sale server such that the inventory management system is updated on a substantially real time basis.

13. The computerized system of claim 12, wherein the host computer is in electrical communication with a plurality of in store processors, the host computer including sufficient memory for at least one relational database which is updated from the in store processors on a substantially real time basis.

14. The computerized system of claim 12 comprising:
an electronic shelf labeling terminal in electrical communication with the in store processor; and
a hand held unit in wireless communication with the electronic shelf labeling terminal, the hand held units being designed to read bar codes of stock items.

15. The computerized system of claim 14 wherein the hand held unit is integrated with the inventory management system and the relational databases of the primary point of sale server to provide an output based on the bar code of each item read of at least one of:
a current price per item;
a quantity of items currently in stock; and
an amount of items sold per time of day.

16. The computerized system of claim 15 wherein the output of the hand held unit is updated on a substantially real time basis.

17. The computerized system of claim 12 comprising:
a host LAN including,
the host computer,
a switch electrically connected to the host computer,
a plurality of main servers electrically connected to the host switch, and
a router electrically connected to the switch; and
an in store LAN electrically connected to the host LAN, the in store LAN including,
the in store processor,
the primary point of sale server,
the secondary point of sale server, and
the plurality of POS terminals;
wherein the host LAN and the in store LAN comprise a wide area network.

18. A computerized system for a retail environment comprising:
a host computer;
an in store processor in electrical communication with the host computer, the in store processor including an inventory management system;
a primary point of sale server in electrical communication with the in store processor, the primary point of sale server having sufficient memory to include a plurality of relational databases which receive and store date;
an electronic shelf labeling terminal in electrical communication with the in store processor; and
a hand held unit in wireless communication with the electronic shelf labeling terminal, the hand held unit being designed to read bar codes of stock items, and is integrated with the inventory management system and the relational databases of the primary point of sale server to provide an output based on the bar code of each item read of at least one of:
a current price per item,
a quantity of items currently in stock, and
an amount of items sold per time of day, and
wherein the output of the hand held unit is updated on a substantially real time basis.

19. The computerized system of claim 18 comprising:
a POS terminal, in electrical communication with the primary point of sale server, for use by a cashier to interact with a customer at a point of sale, the POS terminal including,
a central processing unit,
a cashier display for use by the cashier at the point of sale, and
a customer display for use by the customer at the point of sale,
wherein the cashier display and the customer display are directly controlled by the central processing unit such that they are interactive with each other.

20. The computerized system of claim 19 wherein the primary point of sale server is in electrical communication with a plurality of POS terminals which input data to the relational databases from a plurality of points of sale.

21. The computerized system of claim 20 wherein the in store processor includes an inventory management system which is integrated with the relational databases of the primary point of sale server such that the inventory management system is updated on a substantially real time basis.

22. The computerized system of claim 21, wherein the host computer is in electrical communication with a plurality of in store processors, the host computer including sufficient memory for at least one relational database which is updated from the in store processors on a substantially real time basis.

23. The computerized system of claim 21 comprising:
a host LAN including,
the host computer,
a switch electrically connected to the host computer,
a plurality of main servers electrically connected to the host switch, and
a router electrically connected to the switch; and
an in store LAN electrically connected to the host LAN, the in store LAN including,
the in store processor,
the primary point of sale server,
the plurality of POS terminals;
wherein the host LAN and the in store LAN comprise a wide area network.
